(19) United States
(12) Patent Application Publication
(10) Pub. No.: US 2026/0289887 A1
(43) Pub. Date: Sep. 24, 2026

(54) SYSTEM

(71) Applicant: SoftBank Group Corp., Tokyo (JP)

(72) Inventor: Runa SAWAMURA, Tokyo (JP)

(73) Assignee: SoftBank Group Corp., Tokyo (JP)

(21) Appl. No.: 19/567,075

(22) Filed: Mar. 14, 2026

(30) Foreign Application Priority Data
Mar. 19, 2025 (JP) 2025-045239

(51) Int. Cl. G06T 13/40; G06F 40/289; G06F 40/40; G06V 10/82; G06V 40/16; G10L 25/63

(52) U.S. Cl. CPC G06T 13/40; G06F 40/289; G06F 40/40; G06V 10/82; G06V 40/171; G10L 25/63

(57) ABSTRACT

A system includes a processor that is configured to receive face image data of a deceased person and behavioral data of the deceased person obtained from the Internet, and preprocess the face image data and the behavioral data to extract features therefrom, analyze thought patterns and linguistic characteristics of the deceased person based on the extracted features, and generate a dialogue using a generative artificial intelligence model in accordance with the analyzed thought patterns and linguistic characteristics, and analyze voice data or text data of a user to recognize an emotion of the user, and adjust the thought patterns and the linguistic characteristics of the deceased person used for the generation of the dialogue according to the recognized emotion of the user.

### CROSS-REFERENCE TO RELATED APPLICATION

This application is based on and claims priority under 35 USC 119 from Japanese Patent Application No. 2025-045239 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, generative artificial intelligence technologies have been developed that can generate text, images, audio, and video based on learned patterns. However, existing systems that attempt to reproduce or simulate a deceased person's personality or presence generally rely on simple rule-based chatbots or generic AI models that do not accurately reflect the deceased person's individual thought patterns, linguistic characteristics, and appearance. As a result, such systems frequently produce responses that feel artificial, impersonal, or inconsistent with the way the deceased person actually spoke and behaved. Furthermore, conventional systems typically do not adapt their generated interactions to the emotional state of a user who is communicating with a representation of the deceased, and therefore cannot provide responses that are appropriately sensitive to the user's feelings, such as grief, loneliness, or anxiety. In addition, existing systems that generate images or video of a deceased person often use static images or generic avatars, and do not create new, dynamic video content that faithfully reflects the facial features of the deceased person or synchronizes with AI-generated speech in a coherent manner. Moreover, many current generative AI systems are limited in that they do not provide an integrated mechanism for controlling or steering the output of a generative AI model by using prompts, while simultaneously maintaining consistency with the deceased person's individual patterns. Accordingly, there is a need for a system that can: (i) acquire and preprocess face image data and behavioral data of a deceased person; (ii) analyze and model the deceased person's thought patterns and linguistic characteristics; (iii) generate dialogue using a generative AI model in a manner that reflects such patterns and characteristics; (iv) recognize and respond to a user's emotional state; and (v) generate new video content that visually represents the deceased person, and can be flexibly controlled by prompts, thereby providing a more realistic, personalized, and emotionally adaptive interaction experience.

### SUMMARY

To solve the above-described problems, the present invention provides a system comprising a processor, wherein the processor is configured to receive face image data of a deceased person and behavioral data of the deceased person obtained from the Internet, and to preprocess the face image data and the behavioral data to extract features therefrom. By extracting such features, the processor is enabled to analyze thought patterns and linguistic characteristics of the deceased person based on the extracted features, and to generate a dialogue using a generative artificial intelligence model in accordance with the analyzed thought patterns and linguistic characteristics, so that the generated responses more closely resemble the deceased person's characteristic way of speaking and thinking. The processor is further configured to analyze voice data or text data of a user to recognize an emotion of the user, and to adjust the thought patterns and the linguistic characteristics of the deceased person used for generation of the dialogue according to the recognized emotion of the user, thereby enabling emotionally adaptive responses that are sensitive to the user's current state. In addition, the processor is configured to extract facial features of the deceased person from image data or video data of the deceased person, and to generate new video data representing the deceased person based on the extracted facial features using a generative artificial intelligence model, thus allowing dynamic video content that visually resembles the deceased person to be produced. Furthermore, the processor is configured to receive a prompt for instructing a generative artificial intelligence model to generate a specific output, and to generate the specific output from the generative artificial intelligence model in accordance with the received prompt, thereby enabling flexible control of the generated content while maintaining consistency with the learned patterns of the deceased person. Through these combined means, the system according to the present invention provides an integrated technical solution that realizes lifelike, personalized, and emotionally responsive interactions with a representation of a deceased person in both textual and visual forms.

The term “system” refers to an arrangement of one or more hardware and software components that cooperate to perform the functions described in the claims, including at least one processor and associated memory, storage, and interfaces.

The term “processor” refers to one or more hardware processing units, such as a central processing unit (CPU), graphics processing unit (GPU), digital signal processor (DSP), application specific integrated circuit (ASIC), field programmable gate array (FPGA), or any combination thereof, that executes instructions to perform computational operations.

The term “face image data” refers to digital image data or image frames that include a depiction of at least a portion of a human face of the deceased person, such as still photographs or video frame images, in any suitable format.

The term “behavioral data” refers to data representing actions or activities of the deceased person in an online or digital environment, including but not limited to message histories, social media posts, browsing histories, search histories, and communication logs.

The term “behavioral data of the deceased person obtained from the Internet” refers to behavioral data that has been collected or acquired from network-based services or resources accessible via the Internet, such as web services, cloud platforms, social networks, or messaging services, and that is associated with the deceased person.

The term “preprocess” refers to performing one or more preparatory operations on raw data, such as cleaning, normalizing, resizing, formatting, filtering, detecting regions of interest, or converting data into a representation suitable for subsequent analysis or model input.

The term “features” refers to numerical values, descriptors, vectors, or structured representations derived from raw data, which capture salient properties or characteristics of the data, such as facial landmarks, embeddings, statistical profiles, or linguistic attributes. The term “extract features” refers to computing or deriving features from raw input data, including, for example, computing facial landmark coordinates from images or computing linguistic vectors from text data.

The term “thought patterns” refers to characteristic tendencies or styles in the way the deceased person reasons, responds, or expresses ideas, including preferred topics, recurrent viewpoints, typical response structures, and habitual ways of addressing questions or situations.

The term “linguistic characteristics” refers to properties of the deceased person's language use, such as frequently used words and phrases, sentence structures, idioms, level of formality, tone, and recurring stylistic elements.

The term “analyze” refers to performing one or more computational operations on data, including statistical processing, pattern recognition, classification, clustering, or model-based inference, to derive information or to identify relationships, patterns, or structures in the data. The term “generative artificial intelligence model” refers to a machine learning model or set of models that can generate new data samples, such as text, images, audio, or video, based on patterns learned from training data, and includes, for example, neural network-based language models and generative image or video models.

The term “dialogue” refers to one or more turns of machine-generated text or speech output that are produced in response to user input, and that are intended to simulate conversation with the deceased person.

The term “user” refers to a living person who interacts with the system, for example by providing input data, viewing generated outputs, or communicating with the generative artificial intelligence model.

The term “voice data of a user” refers to digital audio data representing spoken utterances of the user, including, for example, microphone recordings or streamed audio segments.

The term “text data of a user” refers to character-based or symbolic representations of user input, such as typed messages, transcribed speech, or other textual content entered or provided by the user.

The term “recognize an emotion of the user” refers to determining or estimating an emotional state or affective condition of the user, such as happiness, sadness, anger, fear, or neutrality, based on analysis of user voice data, text data, or both.

The term “adjust the thought patterns and the linguistic characteristics of the deceased person used for the generation of the dialogue” refers to modifying parameters, weights, profiles, or selection rules associated with the modeled thought patterns and linguistic characteristics, so that the generated dialogue is adapted in tone, content, or style in accordance with the recognized emotion of the user.

The term “facial features” refers to geometric, photometric, or structural characteristics of a face, including, for example, positions of facial landmarks, shapes of facial components such as eyes, nose, and mouth, and texture or color information related to facial regions.

The term “image data or video data of the deceased person” refers to digital data representing still images or motion pictures that depict the deceased person, including individual photos, sequences of frames, or video files.

The term “new video data representing the deceased person” refers to video data that is generated by the system, rather than directly recorded from a camera, and that visually depicts a face or body that resembles the deceased person, for example as an animated or synthesized video.

The term “prompt” refers to input information supplied to a generative artificial intelligence model that specifies, constrains, or guides the content, style, or form of an output to be generated, and may include textual instructions, parameters, tags, or other control signals. The term “specific output” refers to an output generated by the generative artificial intelligence model that satisfies one or more conditions, requirements, or characteristics indicated by the prompt, such as a particular type of text response, image, or video.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

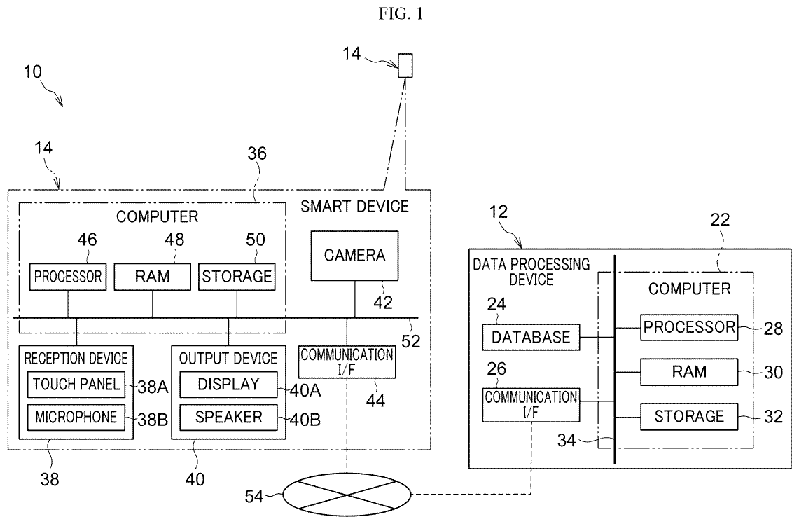

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

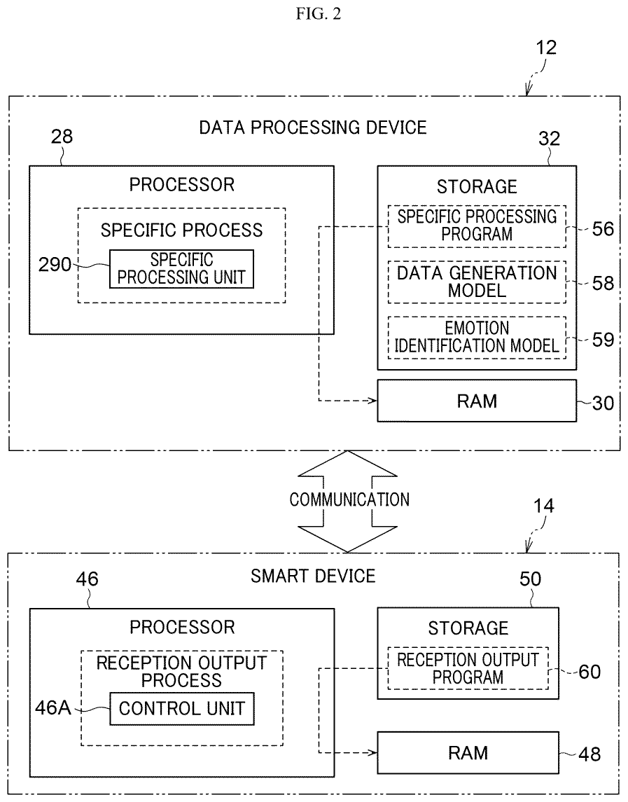

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialogue systems and avatar systems that attempt to reproduce a deceased person's personality generally rely on generic language models and static media data. Such systems typically apply simple keyword-based or template-based personalization to a pre-existing language model, and play back pre-recorded images or videos. As a result, these systems are unable to accurately capture and reproduce nuanced thinking patterns, language patterns, and multimodal behaviors that are specific to an individual person. In particular, known systems do not systematically integrate heterogeneous personal data sources, such as historical communication logs and image data, into a unified training pipeline for a generative artificial intelligence model, and therefore fail to generate responses that consistently reflect that person's characteristic linguistic and behavioral tendencies. Furthermore, many existing systems do not provide a technical mechanism for dynamically adapting the behavior of a generative model in response to the current emotional state of a user. Even when sentiment analysis or emotion recognition is applied, the output of the generative model is often modified in an ad hoc manner at the surface text level, without controlling the generative process itself. This leads to unnatural or inconsistent dialogues, and does not fully exploit the capability of modern machine learning resources to adjust internal output control conditions or vocabulary selection tendencies of the model.

Additionally, existing architectures frequently treat text generation and visual generation as independent processes. There is no tightly coupled mechanism that uses structured facial feature information, extracted from image data of the person being reproduced, in combination with dialogue content to generate synchronized moving images or avatars. Consequently, the visual representation often lacks alignment with the generated text, reducing the realism and coherence of the interactive experience.

From a computer technology standpoint, there is a need for an improved server-side processing architecture that: (i) securely acquires and structurally organizes multimodal personal data (image data and behavior history data), (ii) automatically derives person-specific thinking pattern information and language pattern information as training data sets, (iii) trains dedicated text and image generative models that internalize such person-specific characteristics, and (iv) dynamically controls these models in real time based on user emotional state and prompt sentences. Such an architecture should improve the technical functioning of the server as a data processing apparatus by efficiently managing large volumes of heterogeneous data, by optimizing training and inference flows for generative models, and by producing coordinated text and visual outputs that are algorithmically tailored to the user's current emotional context.

The specific processing by the specific processing unit 290 of the data processing device 12 in Example 1 is realized by the following means.

The present invention provides a server comprising a processor configured to acquire, from a user terminal via a secure communication scheme, image information and behavior history information related to a memorized person, to preprocess the image information using image analysis resources so as to extract face region information and face feature information, to preprocess the behavior history information using natural language processing resources so as to extract phrase sequence information and pragmatic feature information, and to store the extracted information as structured information in an information management mechanism within a storage device, to generate, on the basis of the structured information, a training data set representing thinking pattern information and language pattern information of the memorized person, to train, using machine learning resources, a text generation model and an image generation model as generative artificial intelligence models so as to reproduce the thinking pattern information and the language pattern information of the memorized person, and to store the trained generative artificial intelligence models in the storage device, to acquire prompt sentence information including instruction sentence information from the user terminal, to input the prompt sentence information into at least one of the generative artificial intelligence models, and to generate dialogue sentence information reflecting the thinking pattern information and the language pattern information of the memorized person and transmit the dialogue sentence information to the user terminal, to generate, on the basis of the generated dialogue sentence information and the face feature information, moving image information or avatar image information of the memorized person using the image generation model and image processing resources, to associate the moving image information or the avatar image information with the dialogue sentence information and transmit the moving image information or the avatar image information to the user terminal, and to analyze voice information or text information acquired from a user to estimate emotional state information of the user and, in accordance with the emotional state information, to adjust at least part of output control conditions of the generative artificial intelligence models, vocabulary selection tendency information, and response pattern information so as to dynamically change the thinking pattern information and the language pattern information of the memorized person in the generated dialogue sentence information and moving image information. This enables an improved computer-implemented dialogue and avatar generation process in which a server efficiently integrates multimodal personal data into person-specific generative models, dynamically controls training-derived output conditions during inference in response to user emotional state and prompt sentences, and produces coordinated text and visual outputs that more accurately and consistently reproduce an individual's characteristic thinking and language patterns while enhancing the technical functioning of the underlying data processing system.

The term “user terminal” refers to an information processing device operated by a user, such as a general-purpose computing device, that is capable of transmitting and receiving data to and from a server via a communication network.

The term “secure communication scheme” refers to a communication protocol or mechanism that provides at least confidentiality and integrity for data transmitted between devices, such as an encrypted transport protocol executed over a network.

The term “image information” refers to digital data representing at least one visual depiction of a person, such as pixel data or encoded image files including still images or video frames. The term “behavior history information” refers to digital data representing past activities or actions of a person in an electronic environment, including but not limited to communication logs, browsing logs, and interaction records.

The term “memorized person” refers to a specific individual whose attributes, behaviors, or expressions are to be reproduced or simulated by a system, regardless of whether the individual is living or deceased.

The term “image analysis resources” refers to hardware and software components configured to perform computation related to image processing, such as image decoding, feature extraction, and pattern recognition.

The term “face region information” refers to data indicating a spatial area in an image that corresponds to a human face, including positional or bounding region data.

The term “face feature information” refers to numerical or symbolic data that characterize a human face, such as feature points, embeddings, or descriptors extracted from facial images. The term “natural language processing resources” refers to hardware and software components configured to analyze and process text or speech data, including tokenization, syntactic analysis, and semantic analysis.

The term “phrase sequence information” refers to data representing a sequence of linguistic units, such as words or phrases, obtained from textual content.

The term “pragmatic feature information” refers to data that characterize the usage of language in context, including information about politeness, formality, intent, or conversational role.

The term “structured information” refers to data that is organized according to a predetermined schema or format, enabling indexing, querying, and systematic processing by a computing system.

The term “information management mechanism” refers to a software-controlled component or system, such as a database management system or data storage controller, that stores, organizes, and retrieves structured information in a storage device.

The term “storage device” refers to a hardware component configured to store digital data, including non-volatile and volatile memory such as magnetic storage, solid-state storage, or semiconductor memory.

The term “training data set” refers to a collection of data examples prepared in a form suitable for training a machine learning model, including input-output pairs or input sequences with associated labels.

The term “thinking pattern information” refers to data that represent characteristic tendencies of reasoning, preference, or response of a person in certain situations or contexts.

The term “language pattern information” refers to data that represent characteristic linguistic behaviors of a person, including preferred vocabulary, phrase usage, and stylistic features.

The term “machine learning resources” refers to hardware and software components configured to execute machine learning algorithms, including training and inference processes for models.

The term “text generation model” refers to a parameterized computational model configured to generate textual output based on input data, such as a sequence model or a transformer-based model.

The term “image generation model” refers to a parameterized computational model configured to generate image data based on input data, including models for generating still images or sequences of images.

The term “generative artificial intelligence model” refers to a machine learning model trained to generate new data instances, such as text or images, that are statistically consistent with a given training distribution.

The term “prompt sentence information” refers to data representing at least one user-provided instruction or query expressed in natural language, which is supplied as input to a generative artificial intelligence model.

The term “instruction sentence information” refers to a portion of prompt sentence information that explicitly specifies a desired type, style, or content of an output to be generated by a model.

The term “dialogue sentence information” refers to textual output generated by a system that is formatted or intended as utterances in a dialogue, including single messages and multi-sentence responses.

The term “moving image information” refers to digital data representing a time-varying sequence of images, including video data or animated image sequences.

The term “avatar image information” refers to digital data representing a graphical representation of a person, including static or animated character images or models.

The term “image processing resources” refers to hardware and software components used to manipulate, transform, or encode image data, including rendering, compositing, and video encoding resources.

The term “voice information” refers to digital data representing acoustic signals of spoken language, including digitized audio waveforms and encoded speech streams.

The term “text information” refers to digital data representing characters, words, or symbols in a written language, including plain text and formatted text.

The term “emotional state information” refers to data indicating an estimated emotional condition of a user, such as happiness, sadness, anger, or other affective state categories or dimensions.

The term “output control conditions” refers to parameters or settings that influence the behavior of a generative artificial intelligence model during inference, such as temperature, sampling strategy, length constraints, or conditioning signals.

The term “vocabulary selection tendency information” refers to data that influence or represent preferences in the choice of words or expressions used by a generative artificial intelligence model.

The term “response pattern information” refers to data that characterize structural or behavioral properties of generated responses, such as politeness level, formality, length, or turn-taking style.

The term “vocabulary frequency information” refers to data representing occurrence frequencies of words or phrases in a dataset, including counts or normalized probabilities. The term “collocation pattern information” refers to data representing patterns of co-occurrence of two or more linguistic units within a certain context window.

The term “gratitude expression information” refers to data that specify or identify linguistic expressions used to convey appreciation or thanks.

The term “characteristic expression information” refers to data that specify or identify linguistic expressions that are particularly typical or distinctive of an individual person.

The term “weighting information” refers to numerical or categorical values used to adjust the relative importance or influence of specific data elements or features during model training or inference.

The term “recipient category” refers to a classification of a message recipient, such as friend, family member, colleague, or other role-based or relation-based category.

The term “context information” refers to data that provide situational or relational background for interpreting or generating content, including information about participants, roles, topics, or communication channels.

The term “style information” refers to data that characterize the manner or tone of generated text, including formality, politeness, register, and narrative voice.

In one embodiment, a server, a user terminal, and a communication network cooperate to implement a system that reconstructs patterns of thought and language of a memorized person and generates coordinated dialogue and visual outputs. The server includes at least one processor, a main memory, a persistent storage device, and a network interface. The processor executes program modules stored in the storage device to perform image preprocessing, natural language preprocessing, feature extraction, model training, and model inference. The storage device may be implemented as a magnetic storage medium, a solid-state storage medium, or another non-volatile memory. The network interface may use a wired or wireless communication medium to communicate with the terminal.

The terminal is an information processing device such as a smartphone, a tablet, or a personal computer, including a processor, a display, an input interface, a microphone, and a local storage device. The terminal executes an application realized by general-purpose operating system facilities and a client application. The user operates the terminal to provide initial data related to the memorized person and to conduct interactive sessions by transmitting prompt sentences and receiving generated dialogue sentences and associated images or animations. The user collects image information related to the memorized person and behavior history information related to the memorized person using the terminal. The user causes the terminal to store still images of the memorized person, for example as JPEG files, and to export communication logs or browsing history as structured text files such as comma-separated value files. The terminal may display a list of image files and text files and may allow the user to select which files to upload for training.

The terminal establishes a secure communication channel with the server. The terminal may invoke a secure transport protocol, such as a secure shell file transfer protocol or an encrypted hypertext transfer protocol, through a network stack implemented in the terminal's operating system. The terminal transmits the selected image files and text files to the server over the secure channel. The server receives the transmitted files via a network interface and writes them to a temporary storage area in the storage device.

The server executes an ingestion module implemented, for example, in a general-purpose programming language environment. The server uses a database management system to store structured information. For example, the server uses a relational database engine, and a database access library running in the server's application environment, to insert image records and text records into tables. The server converts each image file into binary data and inserts the binary data into an image table as a binary large object together with metadata such as an identifier of the memorized person and a timestamp. The server parses each behavior history file line by line and inserts textual content, sender and recipient identifiers, and time information into a message table and optionally a browsing history table.

The server performs image preprocessing using image analysis resources. The server loads image records from the database into main memory and decodes the binary data into two-dimensional pixel arrays. The server uses an image processing library such as a widely used open-source computer vision framework to perform face detection, face alignment, and facial landmark extraction. The server executes a face detection algorithm, for example a cascade classifier or a deep neural network-based detector, that scans each image and outputs bounding box coordinates for regions that likely contain a face. The server crops pixel regions corresponding to the bounding boxes and optionally applies normalization operations, such as resizing to a fixed resolution and adjusting color channels.

The server derives face feature information by computing feature vectors from the normalized face regions. The server may apply a pre-trained facial embedding network implemented in a deep learning framework to transform each face image into a fixed-length numerical vector. The server stores the resulting vectors, together with identifiers linking them to the original images, in a feature table in the database or in a separate feature store. The server performs text preprocessing using natural language processing resources. The server retrieves message content from the database and processes the text using a natural language toolkit or similar library. The server tokenizes each message into tokens, removes punctuation, converts tokens to lower case or another normalized form, and removes tokens that correspond to function words considered irrelevant for modeling person-specific patterns. The server optionally applies stemming or lemmatization to reduce inflected forms to canonical forms. The server structures the output as sequences of token identifiers, storing them in one or more tables or in serialized files.

The server extracts language pattern information and pragmatic feature information from the preprocessed text. The server computes vocabulary frequency distributions by counting occurrences of each token across the corpus of messages associated with the memorized person. The server records for each token a frequency count and an estimated probability. The server further computes collocation pattern information, such as bi-gram and tri-gram statistics, by counting pairs or triples of tokens that appear within a defined window. The server identifies characteristic expressions including phrases that occur with high relative frequency for the memorized person but not for a general population. For example, if the phrase “thank you” or an equivalent gratitude expression in another language appears much more frequently than in generic language corpora, the server marks this phrase as gratitude expression information specific to the memorized person.

The server groups messages by recipient category or context, based on metadata or specific keywords. The server may classify each message as addressed to “family”, “friend”, “colleague” or another category by applying a rule-based classifier or a machine learning classifier using features such as the identity of the recipient, keywords, or communication channel. The server thus constructs language pattern information that is conditioned on recipient category.

The server generates a training data set for a text generation model by pairing sequences of token identifiers with target tokens in an auto-regressive language modeling scheme. The server builds an input sequence for each message and associates each position with the next token to be predicted. The server also associates each message with a recipient category label and possibly with other tags such as “gratitude”, “apology”, or “casual chat” inferred from the presence of particular phrases or from rule-based sentiment analysis.

The server defines a neural network architecture for the text generation model in a machine learning framework. In one embodiment, the server constructs a transformer-based sequence model consisting of an embedding layer, a series of self-attention layers, and feed-forward layers. The server sets hyperparameters such as model dimension, number of attention heads, number of layers, and dropout rates. The server selects an optimization algorithm such as an adaptive moment estimation algorithm and defines a loss function such as a cross-entropy loss between predicted token distributions and actual tokens.

The server trains the text generation model using the training data set. The server divides the data into mini-batches and, for each batch, executes the forward pass of the model to compute output token distributions. The server computes the loss for the batch and executes the backward pass to compute gradients of the loss with respect to model parameters. The server updates the model parameters by applying the optimization algorithm. The server may use a graphics processing unit to accelerate matrix multiplications and tensor operations associated with multi-head attention and feed-forward networks. The server repeats this training process over multiple epochs until convergence criteria are met, such as stabilization of validation loss.

The server incorporates the vocabulary frequency information, collocation pattern information, and characteristic expression information into the training procedure. The server assigns higher weights in the loss function to tokens and sequences corresponding to characteristic expressions, such as gratitude expressions, by multiplying the loss terms associated with those tokens by weighting information greater than one. This causes the optimization process to reduce errors on characteristic expressions more aggressively, resulting in a text generation model that preferentially reproduces these expressions when appropriate. This mechanism goes beyond simple script-based substitution and impacts the internal probability distributions of the neural network, thereby modifying its generative behavior in a non-trivial way.

The server also constructs an image generation model or animation model for visual representation of the memorized person. The server defines a neural network architecture that, for example, takes as input face feature information, a phoneme or viseme sequence derived from dialogue text, and an emotion tag, and outputs a sequence of facial image frames. The server may use a generator network based on convolutional or convolutional-transpose layers and may use a discriminator network if a generative adversarial structure is employed. The server trains this model using pairs of recorded facial frames and aligned audio or text, when such data is available, and uses a loss function combining pixel-wise reconstruction error and adversarial loss. The server again uses weighting information to emphasize faithful reconstruction of facial regions representing the memorized person's characteristic expressions, such as particular smiles or eyebrow movements.

The server stores trained model parameters and tokenizer or feature extraction configurations in the storage device and loads them into memory during inference. The server thus maintains a modular architecture including an ingestion module, an image preprocessing module, a text preprocessing module, a feature extraction module, a training module, a text generation inference module, a visual generation inference module, and a dialog orchestration module. Each module exchanges data via defined data structures, such as database tables, serialized records, and in-memory tensors.

The user initiates interactive use of the system by operating the terminal to provide a prompt sentence. The terminal displays an input field and the user enters a text instruction such as: “Please generate a message in which the memorized person expresses gratitude to a close friend.”

“Generate a short message where the memorized person thanks their family for their support.”

“Create a casual chat message from the memorized person to a coworker, showing appreciation for help on a project.”

The terminal transmits the entered prompt sentence to the server via a request message. The server receives the prompt sentence and passes it to the text generation inference module. The server tokenizes the prompt and encodes additional conditioning signals derived from the prompt, such as the presence of the terms “friend”, “family”, or “coworker” mapped to recipient category embeddings. The server feeds the tokenized prompt and conditioning signals into the trained transformer model and generates subsequent tokens by iterative sampling or constrained decoding. The server may adjust output control conditions such as sampling temperature and nucleus sampling threshold based on the prompt and internal user-specific parameters to control creativity and variability of the response.

The server analyzes voice information or text information received from the user during the session to estimate the user's emotional state. For voice information, the server extracts acoustic features such as pitch, energy, and spectral characteristics and applies a classifier trained to produce emotion labels or continuous emotion coordinates. For text information, the server applies a sentiment analysis model or rule-based classifier to detect affective cues such as positive or negative sentiment, urgency, or calmness. The server maps the estimated emotion to emotional state information and uses this information to modify generation behavior at several levels. For instance, the server adjusts the attention bias in the transformer to emphasize tokens associated with comfort or reassurance when the user is detected as sad, and the server reduces variability parameters to avoid surprising or aggressive responses. The server's adjustment of internal parameters in response to emotional state information is not a simple post-processing filter applied to generated text. Instead, the server injects additional conditioning vectors into the transformer's input or intermediate layers, thereby altering the attention distributions and activation patterns during generation. This approach yields a technical effect: the model can generate contextually appropriate responses in fewer decoding steps, reducing the need for regenerations and thus improving latency and computational efficiency on the server. Moreover, by leveraging person-specific language pattern information and emotional conditioning, the model achieves higher alignment with user expectations, reducing the rate of responses that the user rejects or disregards.

The server uses the generated dialogue sentence information and the associated conditioning signals (recipient category, emotion, and characteristic expression flags) to drive the image generation module. The server derives a timing alignment between the generated text and the visual frames by mapping words to phoneme or viseme sequences using a pronunciation dictionary and timing heuristics. The server provides to the generator network the face feature vector of the memorized person, the viseme sequence, and an emotion vector. The generator network outputs a sequence of frames representing the memorized person speaking with corresponding facial expressions. The server encodes the frames into a compressed video or a stream of images and transmits them together with the dialogue sentence information to the terminal.

The terminal receives the dialogue sentence information and the moving image information or avatar image information from the server. The terminal decodes the video stream, displays the animated face or avatar on the display, and shows the generated text as subtitles or chat bubbles. The user may read the message, observe the facial expressions, and continue the conversation by sending additional prompt sentences. The server and terminal thus cooperatively implement a closed-loop interactive system.

The described architecture produces technical advantages beyond mere automation of human communication. By organizing heterogeneous behavioral and visual data into structured information with explicit feature representations, the server can store and retrieve person-specific patterns efficiently. The use of customized weighting in the loss function and multi-dimensional conditioning for both text and image generation leads to improved precision in reproducing individual language and facial behaviors, compared with generic models that do not use such features. The modular design separates resource-intensive training from latency-sensitive inference, allowing the server to schedule training tasks on high-performance hardware while serving many simultaneous inference requests on the same or different hardware.

Furthermore, the server reduces communication load between the server and terminal by transmitting only compact prompt sentences and generated outputs instead of large amounts of raw training data during interaction. All heavy preprocessing, feature extraction, and training are centralized on the server, while the terminal performs only lightweight display and input functions. This improves scalability in networked deployments and allows terminals with limited computing capabilities to participate.

In alternative embodiments, the server may employ different neural architectures such as recurrent neural networks, convolutional seq2seq models, or hybrid architectures, as long as the model parameters are trained using the structured information and weighting strategies described above. The server may also use alternative emotion estimation methods, including unsupervised clustering of user behavior patterns. The feature representation may be extended to include additional modalities such as typing speed, response timing, or physiological signals. The system may further incorporate model compression techniques such as quantization or knowledge distillation to deploy smaller models on resource-constrained servers while maintaining person-specific behaviors.

In another embodiment, multiple memorized persons may be handled by the same server. The server may maintain separate model instances or maintain a unified base model with person-specific parameter adapters. In this case, the server loads the appropriate adapter parameters based on an identifier supplied with the prompt sentence and adjusts generation accordingly.

This structure further reduces memory usage by sharing a base model, thereby improving resource utilization and processing speed across multiple users.

By combining these elements structured feature extraction, weighted learning of characteristic expressions, emotion-conditioned decoding, and synchronized text and image generation the server, terminal, and user cooperatively realize a computer system that materially improves the functioning of the underlying computing platform. The system processes large heterogeneous data sets in a manner that a human could not feasibly replicate, optimizes neural network parameters using non-trivial algorithms tailored to person-specific and emotion-specific conditions, and yields improved accuracy, reduced latency, and enhanced coherence in generated multimodal outputs.

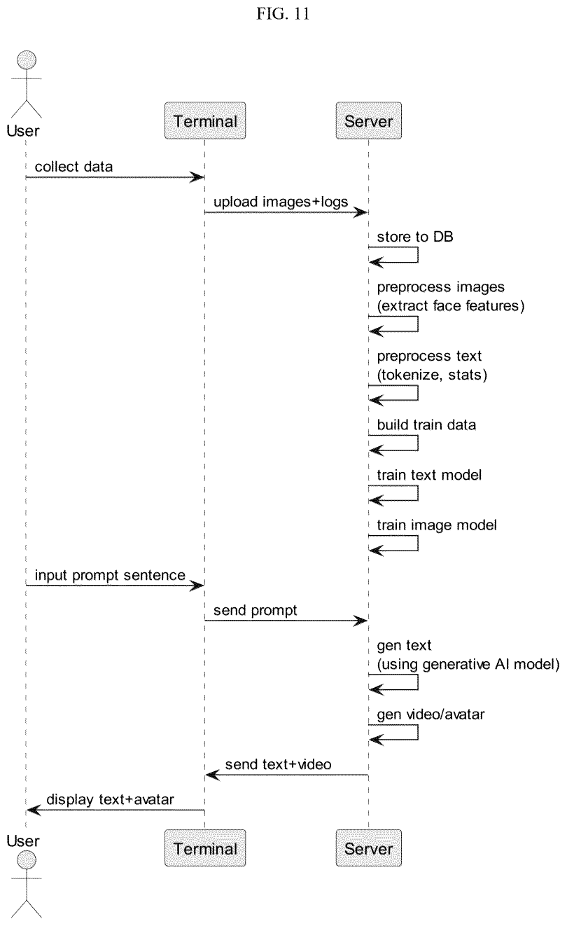

The following describes the processing flow using FIG. 11.

### Step 1

The user collects data related to the memorized person and stores the data on the terminal. The user selects face photos of the memorized person and saves them as image files such as JPEG files in the terminal's local storage.

The user exports communication logs, such as messenger chat histories or email records, and browsing histories as structured text files such as CSV files and stores them on the terminal. The input of this step is raw personal data in heterogeneous formats (image files and text log files), and the output of this step is a set of locally stored files on the terminal that are ready for upload.

### Step 2

The terminal establishes a secure communication channel with the server and uploads the stored data.

The terminal uses a secure transfer protocol implemented in the operating system to open an encrypted session to the server over a communication network.

The terminal reads the selected JPEG and CSV files from local storage and transmits the file contents as encrypted data packets to the server.

The input of this step is the set of image and text files stored on the terminal, and the output of this step is a corresponding set of files written into a temporary storage area on the server.

### Step 3

The server ingests the uploaded data and stores it as structured information in a database.

The server reads each uploaded image file from the temporary storage area as binary data and inserts the binary data with associated metadata into an image table in a database management system.

The server opens each uploaded text log file, parses each line into fields such as sender, recipient, timestamp, and message body, and inserts the parsed fields as records into one or more message tables.

The input of this step is the raw uploaded files stored on the server's file system, and the output of this step is structured database records containing image information and behavior history information indexed by identifiers.

### Step 4

The server performs image preprocessing and facial feature extraction.

The server retrieves image records from the database, decodes the binary image data into pixel arrays in memory, and applies a face detection algorithm to locate face regions within each image.

The server crops the detected face regions, normalizes their size and orientation, and runs a facial embedding network to convert each normalized face region into a fixed-length numerical vector representing face feature information.

The input of this step is the set of stored image records with raw pixel data, and the output of this step is a set of normalized face region data and corresponding face feature vectors stored as structured feature records.

### Step 5

The server performs text preprocessing and linguistic feature extraction.

The server retrieves message bodies from the message tables and passes the text through a natural language processing pipeline that tokenizes sentences, removes stop words, and normalizes word forms.

The server calculates word frequency counts, collocation statistics, and other linguistic statistics, and stores token sequences, token frequencies, and phrase patterns as structured language feature records.

The input of this step is unprocessed textual behavior history information, and the output of this step is preprocessed token sequences and derived statistics representing vocabulary frequency information and collocation pattern information.

### Step 6

The server constructs a training data set for a text generative AI model.

The server converts each tokenized message into a sequence of token identifiers and generates input-output pairs by associating each prefix of a sequence with the next token to be predicted.

The server associates each message with auxiliary labels such as recipient category and expression category (for example, gratitude or apology) based on rules or classifiers and appends these labels as conditioning information in the training data.

The input of this step is the token sequences and linguistic feature records, and the output of this step is a structured training data set consisting of input token sequences, target tokens, and conditioning labels for training the generative AI model.

### Step 7

The server trains the text generative AI model using the constructed training data set.

The server initializes a neural network architecture, such as a transformer-based language model, with embedding layers, self-attention layers, and feed-forward layers, and sets training hyperparameters such as learning rate and batch size.

The server repeatedly reads batches of training examples, performs forward propagation to compute predicted token distributions, computes a loss value using a cross-entropy function that is weighted more heavily for characteristic expressions such as frequently used gratitude phrases, and performs backpropagation to update the model parameters using an optimization algorithm.

The input of this step is the training data set and the initial model parameters, and the output of this step is a trained text generative AI model whose internal parameters have been optimized to reproduce the memorized person's language pattern information.

### Step 8

The server trains an image or avatar generation model for dynamic visual output.

The server prepares training pairs consisting of face feature vectors, associated phoneme or viseme sequences, emotion labels, and target facial image frames of the memorized person when such training data is available.

The server defines a neural network architecture that maps the face feature vectors and sequence features to output image frames, and trains the model by minimizing a combined loss function including pixel reconstruction loss and, if used, adversarial loss.

The input of this step is the facial feature records and aligned audiovisual training samples, and the output of this step is a trained image generation model that can generate moving image information or avatar image information based on face feature information and text-derived timing signals.

### Step 9

The user initiates an interactive session and provides a prompt sentence via the terminal.

The user operates an application on the terminal to open a dialogue interface and enters a prompt sentence such as “Please generate a message in which the memorized person expresses gratitude to a close friend.”

The terminal packages the prompt sentence as a request message and transmits the request to the server over a secure communication channel.

The input of this step is the user's textual instruction entered on the terminal, and the output of this step is a corresponding prompt sentence request delivered to the server.

### Step 10

The server generates dialogue sentence information in response to the prompt sentence. The server tokenizes the received prompt sentence, encodes any recipient category or expression type implied by the text, and feeds the resulting tokens and conditioning signals into the trained text generative AI model.

The server iteratively samples or selects successive tokens based on the model's output distributions and decoding parameters until end conditions are met, then decodes the token sequence into a human-readable response that reflects the memorized person's thinking pattern information and language pattern information.

The input of this step is the prompt sentence and internal model parameters, and the output of this step is generated dialogue sentence information that is tailored to the prompt and the memorized person's learned style.

### Step 11

The server estimates the user's emotional state and adjusts generation conditions.

The server receives voice information or additional text information from the terminal and extracts features such as acoustic characteristics or sentiment indicators.

The server applies an emotion classification algorithm to produce emotional state information and modifies output control conditions of the generative AI model, such as sampling temperature and attention bias vectors, to encourage responses that match the user's emotional needs.

The input of this step is current user interaction data (voice or text) and previous model outputs, and the output of this step is updated generative AI model control parameters that influence subsequent dialogue generation.

### Step 12

The server generates synchronized visual output based on the dialogue and face feature information.

The server derives a sequence of phonemes or visemes from the generated dialogue sentence information and selects or computes an emotion vector corresponding to the user's emotional state and the communicative intent of the response.

The server feeds the face feature vectors of the memorized person, the viseme sequence, and the emotion vector into the trained image generation model and generates a sequence of image frames representing the memorized person speaking the generated dialogue with appropriate facial expressions.

The input of this step is the generated dialogue text, face feature information, and conditioning signals, and the output of this step is moving image information or avatar image information associated with the generated dialogue.

### Step 13

The server transmits the generated dialogue and visual outputs to the terminal.

The server encodes the generated image frames into a video stream or a series of compressed images and packages the video data together with the dialogue sentence text in a response message to the terminal.

The server sends the response over the secure communication channel, ensuring that the message structure allows the terminal to align displayed text with corresponding visual frames.

The input of this step is the generated dialogue sentence information and moving or avatar image information, and the output of this step is a transmitted response message containing synchronized multimodal content.

### Step 14

The terminal presents the generated content to the user and supports further interaction. The terminal receives the response from the server, decodes the video stream or image sequence, and renders the animated face or avatar on the display while showing the dialogue text as chat messages or subtitles.

The terminal optionally captures further prompt sentences or voice input from the user and sends new requests to the server, enabling continuous iterative interaction using the trained generative AI model.

The input of this step is the composite response message from the server, and the output of this step is a displayed and optionally played multimodal representation of the memorized person together with an updated interface state that allows the user to issue subsequent prompt sentences.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional dialogue systems and memorial content generation systems typically rely on generic language models and static media data, such as unprocessed photos, text logs, and prerecorded audio. These systems suffer from several technical limitations in how computing resources are used and how data is processed and integrated. First, conventional systems generally treat user input, stored behavioral data, and generated responses as independent streams, without a unified representation that conditions the generative model on person-specific patterns of language, emotion, and behavior. As a result, existing systems often produce responses that are stylistically inconsistent, context-insensitive, and poorly aligned with the historical data, thereby reducing the practical utility of the hardware resources and the effectiveness of the underlying machine learning pipelines. Second, in many known architectures, the generative model is driven by simple prompts constructed directly from the latest user utterance, with minimal or no structured incorporation of dialogue history, user emotional state, and persona-defining parameters derived from pre-existing data. This causes inefficiencies in model usage, because the same computationally intensive model is repeatedly executed without leveraging richer, precomputed feature parameters that reflect a particular thinking pattern or language style. The computing device therefore performs redundant or suboptimal processing over heterogeneous data sources (images, behavior logs, speech, and text) and cannot fully exploit the available data structure to guide generation.

Third, conventional systems do not provide an integrated, technically grounded mechanism for (i) extracting and normalizing multimodal data related to a specific person (including face images and internet behavior history), (ii) deriving compact feature parameters that represent that person's thinking pattern and language style, and (iii) using those parameters as part of a systematic prompt construction process for a generative AI model, in combination with real-time user input and emotion recognition. In particular, there is no coordinated pipeline that couples natural language processing, feature extraction, context management, prompt generation, and speech synthesis into a single, processor-oriented architecture that is optimized for generating person-specific interactive content.

Fourth, in generating audiovisual responses, typical systems simply overlay synthesized speech onto static images or generic avatars, without a technical scheme for deriving and using face embedding vectors from the person's images to drive synchronized audiovisual output. This leads to disjointed user experiences and underutilization of image-processing capabilities in the computing device, and fails to provide an efficient mapping from image features and text features into coherent, time-aligned audiovisual content.

Accordingly, there is a need for an improved computer-implemented system and method that (i) acquires and normalizes image data and behavior history data related to a specific person, (ii) derives structured feature parameters representing that person's thinking pattern and language style through natural language processing and statistical analysis, (iii) uses those feature parameters, together with dialogue history and user emotional state, to construct technically structured prompt sentences for a generative AI model, and (iv) generates text and audio, and optionally synchronized video content, in a technically efficient manner. Such a system should improve the functioning of the underlying computing device by reducing redundant processing, integrating multimodal data into a unified representation, and enhancing the quality and consistency of generated interactive content through more effective control of the generative AI model.

The specific processing by the specific processing unit 290 of the data processing device 12 in Application Example 1 is realized by the following means.

The present invention provides a server comprising a processor configured to acquire image data and behavior history data related to a deceased person, normalize and structure the image data and the behavior history data, and store the normalized and structured data in a storage device; preprocess text data included in the behavior history data by using a natural language processing function, extract feature quantities including token sequences, lexical statistics, emotional tendencies, and topic tendencies, and generate feature parameters representing a thinking pattern and a language style of the deceased person based on the feature quantities; train or adjust a generative language model based on the feature parameters and dialogue history data to construct a generative AI model that imitates the thinking pattern and the language style of the deceased person; acquire voice data of a user, convert the voice data into text data by using a speech recognition function, and estimate an emotional state of the user from the voice data and the text data by using an emotion recognition function; generate a prompt sentence to be input to the generative AI model based on the dialogue history data, the text data, the emotional state, and the feature parameters, and dynamically generate a text response based on the thinking pattern and the language style of the deceased person by using the prompt sentence; and generate audio data from the text response and voice feature parameters of the deceased person by using a speech synthesis function, and transmit the audio data to a user terminal for output. This enables the computing system to integrate heterogeneous multimodal data into unified feature parameters, to construct technically structured prompt sentences that condition a generative AI model with persona-specific and context-sensitive information, and to generate coherent, person-specific interactive content, thereby improving the efficiency, consistency, and technical performance of dialogue generation and multimedia output in the underlying computer architecture.

The term “image data” refers to digital data representing one or more images, including still images of at least a face region of a person.

The term “behavior history data” refers to digital data representing past activities of a person in an information network environment, including message logs, browsing logs, posting logs, and other interaction records.

The term “storage device” refers to a hardware component or combination of hardware components configured to store digital data, including volatile memory, non-volatile memory, magnetic storage, and semiconductor storage.

The term “natural language processing function” refers to software-implemented processing that analyzes and transforms text data in a human language, including at least tokenization, normalization, and extraction of linguistic features.

The term “text data” refers to digital data representing characters, symbols, or tokens in a human language, including transcribed speech, message logs, and document content.

The term “feature quantities” refers to numerical or symbolic values calculated from input data, representing characteristics of the input data that are used for further analysis or model processing.

The term “token sequences” refers to ordered lists of minimal linguistic units, such as words, subword units, or symbols, generated from text data by a tokenizer.

The term “lexical statistics” refers to statistical values derived from occurrences of tokens in text data, including frequency distributions, co-occurrence statistics, and vocabulary richness indicators.

The term “emotional tendencies” refers to patterns of emotional attributes inferred from text data, including distributions of sentiment categories, affective scores, or emotion labels over time or across topics.

The term “topic tendencies” refers to patterns of subject matter inferred from text data, including distributions of topic categories, topic probabilities, or topic-related keywords.

The term “feature parameters” refers to parameter values derived from feature quantities and used to represent properties of an entity, such as a thinking pattern or a language style, in a form suitable for input to a machine learning model.

The term “thinking pattern” refers to a set of tendencies in how a person responds, reasons, or reacts across situations, represented in the system as feature parameters derived from behavior history data.

The term “language style” refers to characteristic ways in which a person uses language, including preferred expressions, tone, formality, and sentence structure, represented in the system as feature parameters derived from text data.

The term “dialogue history data” refers to digital data representing past exchanges between a user and the system, including at least pairs of user utterances and system responses with associated metadata.

The term “generative language model” refers to a machine learning model configured to generate text sequences based on input sequences, using probabilistic or neural network techniques.

The term “generative AI model” refers to a generative language model that has been trained or adjusted with feature parameters and dialogue history data so as to imitate a specific thinking pattern and language style.

The term “voice data” refers to digital audio data representing sound produced by a human speaker, including at least speech captured by a microphone.

The term “speech recognition function” refers to processing that converts voice data into text data by analyzing acoustic features and mapping them to linguistic units.

The term “emotion recognition function” refers to processing that estimates an emotional state of a person from input data, including at least voice data and text data, by using statistical or machine learning techniques.

The term “emotional state” refers to a representation of a user's current or recent emotion, including, for example, categories such as happiness, sadness, anger, or calmness, or continuous affective values.

The term “prompt sentence” refers to a text sequence that is constructed to instruct or condition a generative AI model, including context information, persona-related metadata, and generation instructions.

The term “text response” refers to text data generated by the generative AI model in response to a prompt sentence and representing an output message to be provided to a user.

The term “voice feature parameters” refers to parameters representing acoustic characteristics of a person's voice, including pitch, timbre, and speaking rate, used as conditioning information for speech synthesis.

The term “speech synthesis function” refers to processing that generates audio data representing speech from input text data and optional voice feature parameters.

The term “user terminal” refers to an electronic device operated by a user, including at least a communication interface, a display, an audio output unit, and optionally an audio input unit, and configured to exchange data with the server.

The term “face region” refers to a portion of an image that contains at least a representation of a person's facial features, such as eyes, nose, and mouth.

The term “face feature extraction function” refers to processing that analyzes a face region and outputs numerical values representing facial characteristics.

The term “face embedding vector” refers to a numerical vector generated by the face feature extraction function and representing a face region in a feature space suitable for comparison or synthesis.

The term “video content” refers to digital data representing time-sequenced image frames, optionally including synchronized audio data, that can be presented as moving images.

The term “facial representation” refers to an image or animated depiction of a person's face generated or selected by the system based on face-related data.

The term “context information” refers to information summarizing recent and past interaction between the user and the system, including utterance content, speaker identities, and dialogue sequence.

The term “metadata” refers to data describing attributes or properties of other data, including at least information indicating a thinking pattern, a language style, or other persona-defining characteristics.

The term “instruction information” refers to data specifying constraints or requirements for generation by the generative AI model, including an emotional tone, a topic, length, or style of a text response.

The term “output having a predetermined expression style and content” refers to generated text or audio that satisfies constraints defined by the prompt sentence, including at least constraints related to tone, topic, and persona-specific characteristics.

In one embodiment, a server, a terminal, and a user cooperate to implement a system that constructs and uses a generative AI model conditioned on persona-specific feature parameters for interactive audiovisual communication.

The server includes at least one processor, a main memory, a non-volatile storage device, and a network interface. The server executes software components implemented, for example, in a high-level programming language runtime such as a Python runtime environment and a web application framework such as a server-side framework. The server may run on a cloud computing instance that includes a graphics processing unit. The terminal includes at least a processor, a memory, a microphone, a speaker, a display, and a wireless communication unit. The terminal executes a client application developed, for example, in a mobile application framework and communicates with the server over a communication network by using a secure protocol.

The server uses a storage device, such as a database system and an object storage system, to store image data and behavior history data related to a deceased person. The server stores, as image data, still images including at least the face region of the deceased person. The server stores, as behavior history data, message logs, browsing logs, posting logs, and other interaction records obtained from one or more network services.

The server normalizes and structures the image data and the behavior history data according to predefined data schemas. The server converts the behavior history data into a canonical text format with a character encoding, attaches metadata such as timestamps, communication counterpart identifiers, and source identifiers, and stores the normalized records into a relational table or a document collection. The server converts the image data into a standard resolution and color format, and stores the processed images into an object store while maintaining a mapping between image identifiers and person identifiers in a metadata table. The server executes a natural language processing function implemented by software libraries such as a natural language processing library and a transformer-based model library. The server tokenizes text data contained in the behavior history data into token sequences. The server uses a tokenizer associated with a base transformer model, for example a byte pair encoding tokenizer or a wordpiece tokenizer, to transform each utterance into a sequence of token identifiers. The server calculates lexical statistics including token frequency distributions, co-occurrence matrices, and sentence length histograms.

The server applies an emotion classification model based on a neural network to the text data. The server uses a neural network such as a bidirectional transformer encoder to infer emotional tendencies for each utterance. The server uses a softmax output layer to assign probabilities to emotion labels such as positive, negative, or neutral. The server aggregates the inferred labels and their probabilities over the dataset to obtain emotion distributions and trends for the deceased person.

The server applies a topic modeling procedure to the text data. The server may use a probabilistic model such as a latent Dirichlet allocation model or a neural topic model implemented over token embeddings obtained from a transformer. The server determines topic probabilities for each document or utterance and aggregates those probabilities to derive topic tendencies for the deceased person.

The server encodes the lexical statistics, emotional tendencies, and topic tendencies as feature quantities. The server reduces the dimensionality of these feature quantities, for example by using a principal component analysis or another projection method, to obtain compact feature parameters representing the thinking pattern and the language style of the deceased person. The server stores these feature parameters as numerical vectors in the storage device, indexed by person identifiers.

The server constructs a generative language model by fine-tuning a pre-trained transformer-based sequence model. The server loads a pre-trained model that has been trained on generic text corpora, and then modifies its parameters by using a training corpus formed from the behavior history data and the feature parameters. The server formats the behavior history data into pairs of input sequences and target sequences, where the input sequences include previous context and the target sequences include corresponding responses. The server optionally appends control tokens or conditioning vectors representing the feature parameters to the input sequences.

The server performs supervised learning using a loss function such as a cross-entropy loss defined over token predictions. The server updates the model weights by using an optimization algorithm such as stochastic gradient descent with momentum or the Adam optimizer. The server applies techniques such as gradient clipping, learning rate scheduling, and regularization to stabilize training. The server may use data augmentation methods such as random masking of tokens or reordering of neutral segments to improve generalization. The server thus obtains a generative AI model, which is a generative language model parameterized not only by general language statistics but also by person-specific feature parameters that represent the thinking pattern and the language style of the deceased person. The server stores the trained model weights and configuration, and registers version information in the storage device.

The server also processes the image data to obtain a face embedding vector for the deceased person. The server executes a face detection algorithm implemented, for example, by a convolutional neural network that predicts bounding boxes for face regions. The server crops each detected face region from the input image and resizes the cropped image to a standard resolution. The server then passes the cropped face image through a face feature extraction network such as a deep convolutional network trained for face recognition. The server obtains a face embedding vector from the activations of a penultimate layer. The server may aggregate multiple face embedding vectors across several images by averaging them or by applying clustering to obtain a representative embedding for the deceased person.

The server uses this face embedding vector to generate or control visual content. The server may cooperate with a talking-head generation module or a generic video synthesis network that receives text or audio features and a face embedding vector and outputs a sequence of image frames where the mouth region and expression change in synchronization with audio. The server synchronizes the timing of the synthesized audio data and the generated frames to create video content in which a facial representation of the deceased person appears to speak the generated text response.

The terminal provides a user interface to the user. The terminal displays, on the display, a list of available deceased persons or profiles. The user selects a profile. The terminal then presents a recording interface with a button that the user can press to start and stop voice input.

The terminal uses the operating system's audio capture interface to acquire voice data from the microphone. The terminal digitizes the signal into a linear pulse-code modulation format at a chosen sampling rate and bit depth. The terminal optionally performs local preprocessing, such as noise reduction, endpoint detection, and compression. The terminal then transmits the voice data to the server through the network interface.

The server receives the voice data and uses a speech recognition function implemented by a speech-to-text engine to convert the audio into text data. The server extracts acoustic features from the audio, such as Mel-frequency cepstral coefficients, and passes these features to an acoustic model based on a recurrent neural network or a transformer model. The server uses a language model to perform decoding and outputs the most probable text sequence. The server stores this recognized text as part of a dialogue history data structure associated with a session identifier and the user identifier.

The server estimates an emotional state of the user from both the voice data and the text data. The server extracts prosodic features such as pitch contours, energy profiles, and speaking rate, and inputs these features into an emotion recognition network such as a convolutional network or a recurrent network trained on labeled emotional speech. The server combines the result with the emotion probabilities estimated from the text data, for example by weighted averaging or by a small fusion network. The server stores the estimated emotional state in the dialogue history data.

The server maintains a dialogue history data structure in a session memory, which may be implemented using a key-value store or an in-memory data store. For each session, the server stores a sequence of entries, each entry including at least a speaker identifier, a text field, a timestamp, and optionally an emotional state. The server may summarize the history by compressing older entries using an abstractive summarization model or by simply truncating entries beyond a configurable limit to control the length of context used for generation.

The server constructs a prompt sentence to condition the generative AI model. The server concatenates context information derived from the dialogue history, metadata indicating the thinking pattern and language style of the deceased person, and instruction information specifying the desired emotional tone and topic of the response. The server may format the prompt sentence with explicit labels such as “System”, “User”, and “Persona” to structure the input.

In one example, the server constructs a prompt sentence as follows:

“You are the deceased person, Ken. You speak in a friendly and slightly humorous tone. The user said: ‘How was your day today?’ In Ken's voice and style, generate a short reply that mentions something the user might enjoy, such as a TV show or a hobby.”

In another example, the server constructs a prompt sentence as follows:
“You are the deceased person, Maria. You were always calm and encouraging. The user said: ‘I feel very lonely these days.’ In Maria's style, generate a comforting and supportive response that acknowledges the user's feelings and gently encourages them.”

In another example, the server constructs a prompt sentence as follows:
“You are the deceased person, Taro. You like to reminisce about shared trips and family events. Conversation so far: User: ‘Do you remember our trip to the sea?’ Task: As Taro, continue the conversation in a nostalgic tone and mention specific details about a seaside trip, such as the weather, the food, or a funny episode.”

The server encodes the prompt sentence into token identifiers using the same tokenizer as used during training. The server also retrieves the feature parameters for the deceased person from the storage device. The server may append a persona token or an embedding derived from the feature parameters to the token sequence before feeding it to the generative AI model. This architecture causes the generative AI model to treat the feature parameters as a conditioning signal that influences word choice, tone, and structure of the generated response.

The server executes the generative AI model on the encoded prompt. The server computes the hidden states of each transformer layer by applying self-attention and feed-forward operations. The server uses a decoding strategy such as nucleus sampling with a threshold to produce a text response that balances diversity and coherence. The server can adjust temperature, repetition penalty, or maximum token length to control the style of the output. The server decodes the token sequence back into text.

The server then applies a safety and consistency filter to the generated text. The server can check for undesired tokens, excessively long repeated subsequences, or outputs that conflict with stored constraints. The server modifies or regenerates the response if necessary. The server generates audio data from the text response. The server uses a speech synthesis function implemented by a text-to-speech engine. The server converts the text response into a phoneme sequence or grapheme sequence, and then uses an acoustic model to predict spectrogram features, followed by a vocoder model to synthesize waveform audio. The server inputs voice feature parameters of the deceased person into the synthesis process to match pitch contours, timbre characteristics, and speaking rate. The voice feature parameters may have been obtained from previously recorded audio of the deceased person or from a generic model adjusted by user selection.

The server produces a digital audio file in a compressed format and transmits the audio data to the terminal via the network interface. In an embodiment including video synthesis, the server also uses the face embedding vector together with the audio features to generate a sequence of facial images synchronized with the speech. The server encodes the frames into a video stream and sends the video along with the audio.

The terminal receives the audio data and optionally video data from the server. The terminal decodes the audio stream and outputs the audio through the speaker. The terminal decodes the video stream and displays the moving facial representation on the display synchronized with the audio. The user thus perceives an integrated audiovisual response that reflects the thinking pattern and language style of the deceased person.

The user may continue the dialogue by responding with further voice input. The terminal repeats the capture and transmission of voice data, and the server repeats recognition, context update, prompt construction, generative model inference, and synthesis.

The described architecture improves computer technology in multiple ways. The server uses a specific combination of data schemas, feature extraction algorithms, and conditioning mechanisms to reduce redundant computations in the generative model. Because the server precomputes and stores feature parameters representing the thinking pattern and language style, the server avoids recalculating such characteristics for each interaction. This reduces processing load and enables faster response generation.

The server constructs prompt sentences that explicitly encode context, persona metadata, and generation instructions. This structured prompt design allows the generative AI model to converge more quickly during training and to generate more accurate and consistent responses during inference, reducing the frequency of regeneration cycles and lowering computational cost. By integrating the emotion recognition function with prompt construction, the server allows the generative model to adapt the emotional tone of responses in a controlled manner, which increases the effectiveness of each inference step.

The server manages dialogue history in a structured data structure and uses summarization or truncation policies that maintain sufficient context without exceeding model limits. This hierarchical context management improves memory usage and reduces the number of tokens processed per request, leading to lower latency and more efficient GPU utilization.

The server employs specific neural network architectures and training methods for natural language processing, emotion recognition, and face embedding extraction. The server configures the generative language model with additional control inputs derived from feature parameters, which is not a mere automation of a human conversation but a modification of the internal representation and functioning of the model. This conditional architecture allows the model to reuse a single set of base weights across multiple personas while changing output behavior through lightweight conditioning, thereby improving scalability and memory efficiency.

The use of face embedding vectors to control synchronized audiovisual generation enables the server to map from image features and text features to coherent video content. This integration results in a technical effect of more compact representation of visual identity and more efficient transmission, because the server can reuse a relatively small face embedding vector and generate multiple frames dynamically instead of storing and transmitting large numbers of prerecorded video files.

The system also improves data management by normalizing heterogeneous data sources into unified schemas and by storing feature parameters in a compact form that can be indexed and retrieved efficiently. This structure reduces communication load between the server and the terminal because the server primarily transmits generated audio and optional video, while larger training and feature extraction computations remain on the server side.

Alternative embodiments are possible. The server may employ different neural network architectures, such as recurrent neural networks with attention mechanisms, convolutional sequence models, or hybrid architectures, to implement the generative language model. The server may use different loss functions, such as label smoothing variants or reinforcement learning from human feedback, to adjust the generative AI model. The server may implement alternative emotion recognition algorithms, such as rule-based postprocessing of prosodic features combined with learned models. The server may implement different face feature extraction algorithms, such as graph-based networks or transformer-based vision encoders. In another embodiment, the terminal may perform some preprocessing locally, such as local speech recognition or emotion estimation, and send only intermediate representations to the server. In yet another embodiment, the server may adjust the granularity of feature parameters at runtime based on available computation resources, switching between coarse persona conditioning and fine-grained style conditioning.

By defining concrete data structures, model architectures, feature quantities, and conditioning mechanisms, and by integrating these components into a specific server-terminal configuration, the system achieves improved processing speed, improved response accuracy and stylistic consistency, reduced communication overhead, and enhanced technical performance in generating person-specific interactive content compared with conventional systems.

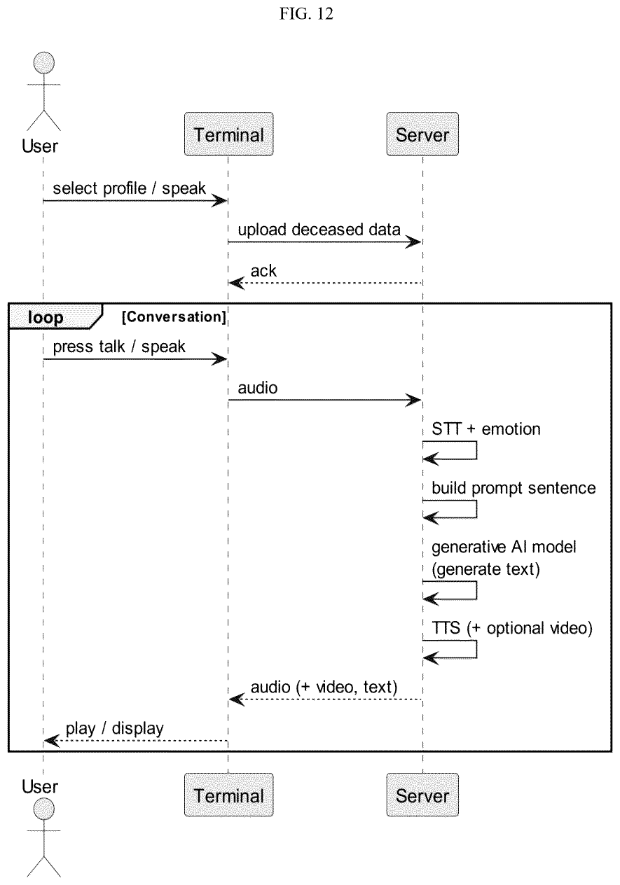

The following describes the processing flow using FIG. 12.

### Step 1

The user provides deceased-person data.

The user selects a deceased person and uploads photos and behavior history files via the terminal.

Input: Raw image files of the deceased person's face, and raw behavior history files such as message logs, browsing logs, and posting logs.

Output: A set of files stored temporarily on the terminal, ready to be transmitted to the server.

### Step 2

The terminal transmits deceased-person data to the server.

The terminal establishes a secure network connection and sends the image files and behavior history files to the server via an API endpoint.

Input: Local image files and behavior history files selected in Step 1.

Output: Network requests containing the deceased-person data, delivered to the server.

### Step 3

The server receives and stores the deceased-person data.

The server accepts the uploaded files, checks file integrity, and stores the raw image data in object storage and the raw behavior history data in a database.

Input: Network packets containing image data and behavior history data from the terminal. Output: Persistent records of image objects and behavior history records associated with a deceased-person identifier.

### Step 4

The server normalizes and structures the behavior history data.

The server converts character encodings, removes invalid characters, splits logs into individual utterances or events, and attaches metadata such as timestamps and source identifiers. The server uses parsing and regular-expression matching to separate speaker labels, message bodies, and URLs.

Input: Raw behavior history records as stored in Step 3.

Output: Normalized and structured text records stored in relational tables or document collections.

### Step 5

The server preprocesses the text data with natural language processing.

The server tokenizes each utterance using a tokenizer compatible with the generative AI model, performs sentence segmentation, and applies normalization such as lowercasing or script unification as applicable. The server uses an NLP library to convert text strings into sequences of token identifiers.

Input: Structured text records from Step 4.

Output: Tokenized text sequences and corresponding token identifier sequences stored in a feature storage area.

### Step 6

The server computes lexical statistics and topic tendencies.

The server counts token frequencies, computes n-gram statistics, and builds co-occurrence matrices. The server applies a topic modeling algorithm to tokenized documents to estimate topic probability distributions for each utterance.

Input: Token identifier sequences from Step 5.

Output: Lexical statistics tables and topic tendency vectors for the deceased person.

### Step 7

The server estimates emotional tendencies from historical text.

The server inputs each utterance into a neural sentiment or emotion classifier and obtains probabilities for predefined emotion categories. The server aggregates these probabilities across the dataset and computes distributions and time-based trends.

Input: Original text utterances or token sequences from Step 5.

Output: Emotional tendency vectors and summary statistics representing the deceased person's historical emotional patterns.

### Step 8

The server generates feature parameters for the thinking pattern and language style.

The server combines lexical statistics, topic tendencies, and emotional tendencies into a unified feature vector. The server applies dimensionality reduction or projection to compress this vector into feature parameters that represent the deceased person's thinking pattern and language style in a compact numerical form.

Input: Lexical statistics, topic tendency vectors, and emotional tendency vectors from Steps 6 and 7.

Output: Persona-specific feature parameters stored as numerical vectors indexed by the deceased-person identifier.

### Step 9

The server processes face images and generates face embedding vectors.

The server detects face regions in each image using a face detection network, crops and resizes the face regions, and feeds them into a face feature extraction network. The server averages or otherwise aggregates multiple embedding vectors to obtain a representative face embedding vector.

Input: Image data of the deceased person from Step 3.

Output: One or more face embedding vectors representing the deceased person's facial characteristics.

### Step 10

The server prepares the training corpus for the generative AI model.

The server extracts dialogue-like segments from the behavior history data, pairs user-side and deceased-side utterances where available, and constructs input-output pairs. The server attaches the feature parameters as conditioning information to each training sample.

Input: Tokenized text sequences and feature parameters from Steps 5 and 8.

Output: A structured training dataset containing input context sequences, target response sequences, and associated feature parameters.

### Step 11

The server fine-tunes a base generative language model.

The server loads a pre-trained transformer-based language model and trains it on the prepared corpus. The server feeds batches of input sequences plus conditioning feature parameters into the model, computes cross-entropy loss over predicted tokens versus target tokens, and updates model weights using an optimization algorithm.

Input: Training dataset from Step 10 and base model weights.

Output: A trained generative AI model whose parameters reflect both general language knowledge and persona-specific thinking pattern and language style.

### Step 12

The server registers and stores the trained generative AI model.

The server saves the model weights, tokenizer configuration, and metadata such as version and associated deceased-person identifier into persistent storage. The server records model location and configuration in a model registry table.

Input: Trained model parameters from Step 11.

Output: A registered generative AI model accessible by identifier during inference.

### Step 13

The user initiates a conversation via the terminal.

The user selects the deceased-person profile on the terminal interface and presses a start button to begin voice input.

Input: User selection and UI interaction.

Output: A session identifier on the terminal and a request sent to the server to start a new dialogue session.

### Step 14

The terminal records the user's speech.

The terminal activates the microphone, records audio frames while the user speaks, performs optional local noise reduction and endpoint detection, and buffers the audio in memory.

Input: Analog speech from the user.

Output: Digital audio samples representing the user's voice utterance.

### Step 15

The terminal sends the recorded audio to the server.

The terminal packetizes the audio data into a request, attaches session and user identifiers, and transmits the request through a secure network channel.

Input: Buffered digital audio from Step 14.

Output: Network packets carrying the user's voice data to the server.

### Step 16

The server converts the user's speech to text.

The server feeds the audio data into a speech recognition engine, which extracts acoustic features and decodes them into a text sequence. The server may apply postprocessing such as punctuation insertion and capitalization.

Input: Audio data from Step 15.

Output: Recognized text representing the user's latest utterance.

### Step 17

The server estimates the user's current emotional state.

The server analyzes acoustic features such as pitch and energy from the audio and text-based features from the recognized text using emotion recognition models. The server fuses these estimates to derive an emotional state label or vector.

Input: Audio data and recognized text from Step 16.

Output: An emotional state representation for the user's latest utterance.

### Step 18

The server updates the dialogue history.

The server appends a new entry containing the user's utterance text, emotional state, timestamp, and speaker identifier to the dialogue history for the active session. The server may summarize or truncate older entries to maintain a manageable context length.

Input: Recognized text and emotional state from Steps 16 and 17, and existing dialogue history.

Output: An updated dialogue history structure stored in session memory.

### Step 19

The server constructs a prompt sentence for the generative AI model.

The server combines recent dialogue history, the deceased-person feature parameters, and the current emotional state to produce a prompt sentence that instructs how the generative AI model should respond. The server inserts guidance phrases that specify tone, topic, and persona.

Input: Dialogue history from Step 18, feature parameters from Step 8, and emotional state from Step 17.

Output: A structured prompt sentence in natural language prepared for tokenization.

### Step 20

The server tokenizes and encodes the prompt sentence.

The server applies the model's tokenizer to convert the prompt sentence into a sequence of token identifiers and optionally concatenates control tokens or learned embeddings derived from the feature parameters.

Input: Prompt sentence from Step 19 and persona feature parameters.

Output: Encoded model input consisting of token identifiers and conditioning vectors.

### Step 21

The server generates a text response using the generative AI model.

The server feeds the encoded input into the generative AI model, performs forward passes through the transformer layers, and decodes the output distribution into a sequence of response tokens using a sampling or beam-search strategy. The server decodes token identifiers back to text.

Input: Encoded prompt and conditioning information from Step 20, and the trained generative AI model from Step 12.

Output: A text response that imitates the deceased person's thinking pattern and language style and is adapted to the user's context and emotional state.

### Step 22

The server validates and postprocesses the text response.

The server checks the response for repetition, length constraints, and prohibited content. The server may adjust punctuation, fix minor formatting issues, or regenerate the response if validation fails.

Input: Raw generated text response from Step 21.

Output: A cleaned and validated text response ready for synthesis.

### Step 23

The server synthesizes speech from the text response.

The server submits the text response, together with voice feature parameters of the deceased person, to a speech synthesis engine. The engine produces audio samples that reflect the desired voice characteristics.

Input: Validated text response from Step 22 and voice feature parameters for the deceased person.

Output: Audio data representing the response spoken in a voice resembling the deceased person.

### Step 24

The server optionally generates synchronized visual content.

The server combines the face embedding vectors with audio timing information to drive a visual synthesis module that produces a sequence of frames of a facial representation synchronized with the synthesized speech.

Input: Face embedding vectors from Step 9 and audio data from Step 23.

Output: Video content in which a facial representation of the deceased person appears to speak the text response.

### Step 25

The server transmits the generated content to the terminal.

The server packages the audio data, and optionally video data and the text response, into a response message and sends it to the terminal via the network.

Input: Audio data from Step 23, optional video from Step 24, and text response from Step 22.

Output: Network packets carrying multimedia response content to the terminal.

### Step 26

The terminal presents the response to the user.

The terminal decodes the received audio and video streams, plays the audio through the speaker, and displays any visual content on the display. The terminal may also show the text response in a chat-style interface.

Input: Multimedia response payload from Step 25.

Output: Audible and optionally visual output presented to the user.

### Step 27

The user continues or ends the conversation.

The user listens to or watches the response and decides whether to ask another question or terminate the session. If the user continues, the user again provides speech input through the terminal, and the sequence from Step 14 onward is repeated.

Input: Perceived response output from Step 26 and user intention.

Output: Either new voice input leading to another loop of processing, or a command to end the session.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialog systems and avatar systems typically employ generic language models and generic visual synthesis engines that are configured independently of user-specific communication patterns. Such systems generally fail to reproduce personalized linguistic behavior, emotional nuance, and temporally consistent facial motion in response to user interaction. As a result, these systems are limited in their ability to generate interactive content that accurately reflects an individual's characteristic thought patterns and language characteristics, while also providing synchronized audiovisual output in real time or near-real time.

From the perspective of computer technology, existing architectures usually process text, emotion, and visual data in separate pipelines that are only loosely coupled at the application layer. A text generation engine may ignore user emotion detected at run time, and a visual generation engine may merely overlay lip movements without being driven by structured prosodic or phoneme-level information derived from synthesized speech. This loose coupling leads to increased latency, redundant computations across components, and inconsistencies between generated text, synthesized speech, and facial expressions. Furthermore, many systems lack a mechanism to dynamically adjust internal generation parameters of a generative AI model based on real-time analysis of user emotion and scene-level instructions embedded in prompt sentences. Thus, the produced responses are often rigid, context-insensitive, and technically inefficient in terms of computation and data flow.

In addition, conventional systems generally do not provide an integrated mechanism for (i) modeling an individual's thought patterns and language characteristics from heterogeneous data sources such as image information and behavior information on a communication network, (ii) combining such models with run-time prompt analysis to form structured context information, and (iii) binding this structured context to both a generative language processing model and a visual generative model in a unified generation pipeline. Consequently, the system cannot efficiently reuse learned numerical feature quantities across text, audio, and video modules, and must repeatedly perform similar analyses, which degrades processing performance and scalability on server hardware.

Accordingly, there is a need for an improved computer-implemented system that, by means of specific data acquisition, preprocessing, feature extraction, model configuration, and synchronized audiovisual generation steps, technically enhances the way a server computes user-personalized dialog content. Such a system should reduce redundant processing, allow dynamic adjustment of generation parameters in response to user emotion and prompt semantics, and tightly synchronize generative language processing with generative visual processing and speech synthesis. By doing so, the system can improve overall computational efficiency, response quality, and consistency of multimodal output, thereby improving the functioning of the computer system itself rather than merely automating a mental process.

The specific processing by the specific processing unit 290 of the data processing device 12 in Example 2 is realized by the following means.

The present invention provides a server comprising a processor and a communication interface, the processor being configured to acquire, via the communication interface and an external storage device, image information and behavior information related to an individual, to preprocess text information included in the behavior information using a natural language processing program to generate structured preprocessed data with grammatical information and emotion information, to extract numerical feature quantities representing thought patterns and language characteristics of the individual from the preprocessed data by statistical processing or machine learning processing, to train or configure a generative language processing model based on the numerical feature quantities so as to determine generation parameters for generating dialogue text, to receive a prompt sentence from a terminal operated by a user and analyze the prompt sentence to detect an instruction specifying at least one of a dialogue scene, a topic, a conversational atmosphere, and an emotional tone, to construct context information for the generative language processing model by selecting or weighting at least one of a vocabulary distribution, a style pattern, and an emotion tendency among the thought patterns and the language characteristics in accordance with the detected instruction and the generation parameters, to obtain voice information or text information from the user and perform emotion analysis processing on the obtained information so as to identify an emotion state of the user and dynamically adjust the generation parameters in accordance with the identified emotion state, to operate the generative language processing model on the basis of the context information and the adjusted generation parameters so as to generate dialogue text, to apply an image processing program and a facial feature extraction algorithm to the image information to extract numerical feature quantities indicative of facial shape information and expression information of the individual, to generate a sequence of image frames expressing facial movements and expressions of the individual by using a generative model for visual information generation based on the numerical feature quantities and the dialogue text, to generate voice information corresponding to the dialogue text by performing speech synthesis processing, to time-synchronize the voice information and the sequence of image frames to generate an audio-attached moving image, and to transmit the dialogue text and the audio-attached moving image to the terminal via the communication interface. This enables an integrated and technically improved generation pipeline in which user-specific language modeling, prompt-based context construction, real-time emotion-driven parameter adjustment, and synchronized multimodal (text, audio, and video) generation are tightly coupled within the server, thereby reducing redundant computation, improving consistency between generated modalities, and enhancing the overall performance and functioning of the computer system.

The term “system” refers to a combination of at least one hardware device and at least one software component that cooperate to perform one or more functions described in the claims.

The term “server” refers to a computing apparatus that includes at least one processor, at least one memory, and at least one communication interface, and that is configured to provide processing or storage services to one or more external devices via a communication network. The term “processor” refers to one or more hardware processing units, such as a central processing unit, a graphics processing unit, a digital signal processor, or any combination thereof, that execute instructions to perform logical, arithmetic, control, or input/output operations.

The term “communication interface” refers to a hardware and software interface that enables the server to exchange data with an external device or network, and may include a network interface card, a wireless transceiver, or a communication port compliant with a communication protocol.

The term “external storage device” refers to a storage apparatus that is physically or logically separate from the processor and that is configured to store data accessible by the server via a communication interface or a storage interface.

The term “image information” refers to data representing visual content, including still images and moving images, that depict at least a part of an individual, such as a face or body, in a digital format.

The term “behavior information” refers to data representing activities of an individual on a communication network, including but not limited to messages, posts, browsing histories, interaction logs, and other records of operations performed in a digital environment.

The term “communication network” refers to any wired or wireless network system that enables data exchange between computing devices, including local area networks, wide area networks, and public networks.

The term “data set” refers to a logically grouped collection of data elements, including image information and behavior information, that are stored in association with one another for processing by the server.

The term “text information” refers to data consisting of characters or symbols that can be processed as natural language, including messages, posts, comments, transcripts, and other textual records.

The term “natural language processing program” refers to software instructions that, when executed by a processor, analyze or transform text information in accordance with rules or models of human language, such as tokenization, part-of-speech tagging, syntactic analysis, or semantic analysis.

The term “preprocessed data” refers to data obtained by applying at least one preprocessing operation to raw text information, the preprocessing operation including removal of unnecessary information, segmentation, and annotation with linguistic or emotion-related information.

The term “grammatical information” refers to information indicating linguistic categories or structures of text, including part-of-speech tags, syntactic roles, or dependency relations assigned to words or phrases.

The term “emotion information” refers to information indicating an emotional attribute or sentiment associated with text information, including labels such as positive, negative, neutral, or specific emotional categories.

The term “statistical processing” refers to computational operations that use quantitative methods, such as frequency analysis, probability estimation, or vector space modeling, to derive numerical representations from data.

The term “machine learning processing” refers to computational operations in which a model is trained, using example data, to automatically learn parameters that map input data to one or more outputs, such as classifications, predictions, or generated content.

The term “numerical feature quantity” refers to a value or vector of values, represented in numerical form, that characterizes a property of data, such as word usage, style, emotion, topic, facial structure, or expression.

The term “thought patterns” refers to patterns in an individual's typical responses or attitudes inferred from behavior information, including preferences, tendencies in reasoning, and consistent ways of reacting to topics or situations, represented as numerical feature quantities.

The term “language characteristics” refers to attributes of an individual's language use, including vocabulary distribution, style patterns, syntactic structures, and typical expressions, represented as numerical feature quantities.

The term “generative language processing model” refers to a computational model that, given input data including text or context information, automatically generates new text sequences using learned parameters derived from training data.

The term “generation parameters” refers to internal parameters, configuration values, or model states that control behavior of a generative language processing model during text generation, including weights, biases, and decoding parameters.

The term “dialogue text” refers to text generated by the system that represents at least one utterance in a conversational form, such as a response to an input prompt sentence.

The term “terminal” refers to an external device operated by a user, such as a personal computer, a smartphone, or a tablet, that communicates with the server and provides an interface for input and output.

The term “user” refers to a person who operates a terminal to interact with the server, including by submitting prompt sentences and consuming generated output.

The term “prompt sentence” refers to an input text sequence provided by the user that instructs the generative language processing model regarding desired content, scene, topic, or style of generated output.

The term “instruction” refers to an element in the prompt sentence that specifies at least one of a dialogue scene, a topic, a conversational atmosphere, or an emotional tone for use by the generative language processing model.

The term “vocabulary distribution” refers to a statistical representation of word usage, including frequencies or probabilities of words or phrases associated with an individual's language characteristics.

The term “style pattern” refers to a pattern describing how an individual constructs utterances, including sentence length, punctuation usage, formal or informal registers, and typical phrasing.

The term “emotion tendency” refers to a pattern describing how an individual's emotional expressions vary across topics or contexts, as inferred from behavior information.

The term “context information” refers to structured information derived from generation parameters, thought patterns, language characteristics, and analysis of a prompt sentence, and supplied to a generative language processing model to influence generated output.

The term “voice information” refers to audio data representing spoken language, including recorded speech from a user or synthesized speech generated by the system.

The term “emotion analysis processing” refers to computational operations that determine an emotion state of a user by analyzing voice information or text information, including use of classification models or rule-based algorithms.

The term “emotion state” refers to a detected or inferred emotional condition of a user, such as happiness, sadness, anger, fear, or a numerical sentiment score.

The term “image processing program” refers to software instructions that, when executed by a processor, analyze or manipulate image information, including detection, segmentation, or enhancement operations.

The term “facial feature extraction algorithm” refers to an algorithm that detects and extracts structural or appearance-related features from images of a face, such as positions of facial landmarks, contours, or texture descriptors.

The term “facial shape information” refers to information indicating geometric or structural aspects of a face, including positions of key points, contours, and relative distances, represented as numerical feature quantities.

The term “expression information” refers to information indicating dynamic or static facial expressions, such as smiling, frowning, or speaking-related mouth shapes, represented as numerical feature quantities.

The term “generative model for visual information generation” refers to a computational model that generates image data, including sequences of image frames, based on input numerical feature quantities and optional auxiliary information such as text or audio.

The term “image frame” refers to a single still image that forms part of a sequence of images in a moving image.

The term “sequence of image frames” refers to an ordered set of image frames that, when displayed in temporal order, represent motion such as facial movements and expressions. The term “speech synthesis processing” refers to computational operations that convert input text into synthetic speech, producing voice information as an audio signal.

The term “audio-attached moving image” refers to data that combines a sequence of image frames and associated voice information in a time-synchronized manner, and that can be played back as a video with audio.

The term “video signal” refers to data representing a time-varying visual sequence, including encoded or unencoded sequences of image frames suitable for display on a terminal.

In one embodiment, a server implements the claimed system as a network-accessible platform that interacts with at least one terminal operated by a user. The server comprises at least one processor, at least one memory, and at least one communication interface connected to a communication network. The processor executes stored programs that perform acquisition, preprocessing, feature extraction, model training, model serving, and audiovisual generation as described below.

The server uses general-purpose computing hardware such as an x86_64 or ARM-based server machine running a server operating system (for example, a Linux-based operating system). The server optionally uses specialized hardware accelerators such as a graphics processing unit with a parallel architecture (for example, a GPU compatible with a parallel computation framework) to perform neural network training and inference. The server uses non-transitory storage such as a solid-state drive or a network-attached storage system to persist data sets, model parameters, and generated audiovisual content.

The terminal is realized as a user device such as a smartphone, a tablet, or a personal computer. The terminal includes a display, at least one input device (for example, a keyboard, a touch panel, or a microphone), at least one processor, and a communication interface. The terminal executes an application or a browser-based client that communicates with the server using secure transport protocols. The terminal presents a graphical user interface for receiving a prompt sentence and for displaying generated dialogue text and playing back audio-attached moving images.

The user operates the terminal to initiate a session with the server. The user inputs a prompt sentence in natural language via a text input field or voice input that is transcribed into text. Examples of prompt sentences include:

“Please recreate a scene where the deceased thanks a close friend for long-lasting support.”

“Please let the deceased give me advice about my current job stress, using their usual way of speaking.”

“Please generate a message in which the deceased thanks their family at a birthday party.”

“Please let the deceased give me warm words of encouragement for my new job, in their usual gentle tone.”

“Please generate a conversation where the deceased talks about their favorite travel memories and gives advice on where I should visit next.”

“Please recreate the kind of message the deceased would send to comfort a friend who is feeling lonely.”

The terminal transmits the prompt sentence, together with a user identifier, to the server through the communication interface.

In one embodiment, the server acquires image information and behavior information related to an individual from multiple heterogeneous data sources. The server accesses remote storage services, mail servers, message archives, and web service APIs to obtain photos, videos, text messages, social media posts, and browsing logs. The server uses a relational database management system or a document-oriented database as an external storage device to store a unified data set. The server organizes the data in a data schema that includes tables or collections for image information, behavior information, and metadata such as timestamps, communication partners, and topics. The behavior information is stored as text records associated with the individual's identifier.

The server applies a natural language processing program implemented, for example, with a combination of text processing libraries to preprocess text information contained in the behavior information. The server removes unnecessary information such as markup tags, URLs, signatures, and system notifications. The server segments each text record into sentences and words and assigns grammatical information (for example, part-of-speech tags and dependency relations) and emotion information (for example, sentiment labels or emotion categories) to each segment. The server stores the preprocessed data as structured records, for example, as rows in a database table or as structured documents, including fields for tokenized text, grammatical tags, and emotion labels.

The server performs statistical processing and machine learning processing on the preprocessed data to derive numerical feature quantities that represent thought patterns and language characteristics of the individual. The server computes word and phrase frequency distributions and constructs n-gram models for typical expressions. The server projects text segments into a vector space by applying embedding methods such as word embeddings or contextual embeddings implemented on a neural network with multiple layers (for example, a transformer-based encoder). The server clusters embeddings and computes topic distributions by applying unsupervised learning algorithms. The server correlates topics with emotion labels to derive emotion tendencies and topic tendencies, and aggregates these across the individual's data. The server stores the aggregated numerical feature quantities in a feature store, for example, as vectors indexed by feature type and individual identifier.

In a preferred embodiment, the server configures a generative AI model that constitutes a generative language processing model. The server uses a neural network architecture based on a transformer with multiple stacked self-attention layers, feed-forward layers, and layer normalization. The server initializes the model with pre-trained parameters obtained from training on a large, generic text corpus. The server then fine-tunes the model on the individual's behavior information by constructing training sequences that include dialogue context and the individual's response. The server uses the numerical feature quantities as additional conditioning inputs, for example, by concatenating or injecting feature vectors into the model's input embeddings or attention mechanisms.

During fine-tuning, the server defines an objective function such as a cross-entropy loss between the generated tokens and the ground-truth tokens in the individual's historical responses. The server performs mini-batch gradient descent with an optimizer such as an adaptive learning rate optimizer. The server updates the model's weight parameters, including attention weights and feed-forward network weights, by backpropagating gradients through the transformer layers. The server can apply data augmentation techniques such as paraphrasing or controlled noise injection to increase robustness and reduce overfitting. The server monitors validation loss, perplexity, and style-matching metrics to decide when to stop training and to select generation parameters such as temperature, top-k, and top-p for decoding.

The server stores the trained generative AI model and associated generation parameters as a model instance associated with the individual. The server uses a model-serving framework or a dedicated inference service to expose an interface that receives prompt sentences and context information and returns generated dialogue text.

When the terminal sends a prompt sentence, the server analyzes the prompt sentence to detect instructions that specify at least one of a dialogue scene, a topic, a conversational atmosphere, and an emotional tone. The server applies an instruction parser implemented, for example, as a rule-based parser and/or a classifier trained on annotated prompt sentences. The server extracts elements such as scene (for example, birthday party, workplace discussion), topic (for example, family, travel), and tone (for example, comforting, encouraging). The server then uses these extracted elements to select or weight the vocabulary distribution, style patterns, and emotion tendencies previously computed for the individual. The server constructs context information as a structured data object that includes the prompt sentence, selected feature vectors, scene and topic indicators, and desired emotional tone parameters. The server receives voice information or text information from the user during the session. When the user provides voice information through the terminal, the terminal captures the audio and transmits it to the server. The server employs a speech-to-text program to obtain a transcript, and then applies emotion analysis processing to both the audio and the transcript. For the audio, the server extracts acoustic features such as pitch, energy, and spectral characteristics, and feeds them to an emotion classification model, for example, a neural network with convolutional layers or recurrent layers. For the text, the server uses a text-based emotion classifier, for example, a transformer-based model, to assign emotion labels or scores. The server fuses acoustic and textual emotion estimates and identifies an emotion state such as “stressed,” “sad,” or “joyful.”

The server dynamically adjusts generation parameters of the generative AI model based on the identified emotion state. For example, the server modifies the probability distribution over emotion styles, shifts vocabulary preferences toward more comforting or more neutral words, or changes decoding parameters to increase or decrease variability in responses. The server updates a parameter vector that influences the generative AI model's hidden layers, for example, by using the emotion state as an additional conditioning input into the transformer's attention mechanism. By doing so, the server causes the generative AI model to generate dialogue text whose style and emotional nuance adapt to the user's real-time emotional condition.

The server then operates the generative AI model with the constructed context information and adjusted generation parameters. The server feeds a tokenized representation of the prompt sentence and auxiliary context tokens representing scene, topic, and emotion into the model. The model generates a sequence of tokens representing dialogue text that imitates the individual's thought patterns and language characteristics. The server performs decoding with controlled sampling strategies that are configured to maintain fluency while preserving stylistic consistency. The server outputs the generated dialogue text to the terminal and also passes the text to downstream modules for audiovisual generation.

In parallel, the server uses the stored image information to generate visual output. The server runs an image processing program to detect faces and facial landmarks in the image information. The server applies a facial feature extraction algorithm, for example, a deep neural network trained for face recognition, to compute facial shape information and expression information as numerical feature quantities. The server stores these feature quantities in association with the individual's identifier.

The server uses a generative model for visual information generation to produce a sequence of image frames representing facial movements and expressions synchronized with the generated dialogue text. In one embodiment, the generative model is implemented as a neural network that takes as input a static reference image representing the individual and a sequence of driving signals derived from speech or phoneme sequences. The server first performs speech synthesis processing, converting the dialogue text into voice information by applying a text-to-speech model. The text-to-speech model may include an encoder that maps text to a latent representation, a decoder that produces a mel-spectrogram, and a vocoder that converts the spectrogram to a waveform. The server then uses a phoneme aligner to map time intervals in the audio to phoneme labels.

The server feeds the phoneme sequence and timing information, together with the facial shape information and expression information, into the visual generative model. The visual generative model computes per-frame facial geometry and texture updates that reflect mouth shapes and expressions corresponding to the phonemes. The server generates an ordered sequence of image frames that display the individual's face speaking the generated dialogue text. The server combines the voice information and the sequence of image frames into an audio-attached moving image by multiplexing video and audio streams in a standardized container format. The server adjusts timing so that the mouth movements and expressions align with the speech waveform.

The terminal receives the dialogue text and the audio-attached moving image from the server. The terminal displays the dialogue text as captions or in a chat-style interface and plays back the audio-attached moving image on the display with audio output. The user can view and listen to content in which the individual appears to speak in a style consistent with the learned thought patterns and language characteristics, and in a manner that responds to the user's prompt sentence and emotional state.

This architecture provides technical improvements over conventional systems in several respects. The server reuses numerical feature quantities across the generative AI model, the emotion analysis module, and the visual generative model, thereby reducing redundant computation. The integrated feature store and structured context information reduce data transfer overhead between modules and minimize repeated analysis of the same data. The dynamic adjustment of generation parameters based on real-time emotion analysis and prompt instruction parsing enables the generative AI model to adapt its internal operation without re-training, improving response quality and reducing latency. The tight synchronization between speech synthesis and visual generation, based on shared timing and phoneme-level information, yields more accurate lip synchronization and more natural audiovisual output, which reduces artifacts and error rates compared to naive lip animation approaches.

Moreover, the server implements specific neural network architectures (for example, transformer-based language models and motion-conditioned image generators) with defined loss functions, optimization strategies, and data flows. These architectures and data flows are designed to exploit the server's parallel processing hardware, resulting in higher throughput and lower latency. By structuring the computation into reusable feature extraction, conditioning, and generation modules that share common representations, the system improves memory locality and cache usage, further improving computational efficiency. The server's processing is not a mere automation of a human mental process, because the server performs high-dimensional numerical optimization, distributed feature reuse, and multimodal signal synchronization in a manner that cannot be practically replicated by a human operator. In alternative embodiments, the server can vary specific model architectures while maintaining the same overall data flow. For example, the server can replace a transformer-based language model with a recurrent neural network architecture or with a hybrid model that combines convolutional and attention layers. The server can implement the visual generative model as a motion transfer network, a three-dimensional morphable model, or a generative adversarial network. The emotion analysis module can use different feature sets (for example, prosodic features, lexical features, or physiological signals) and different classifiers (for example, random forest, support vector machine, or deep neural network). In each case, the server still constructs numerical feature quantities representing thought patterns, language characteristics, facial shapes, and expressions, and still uses those quantities to condition the generative AI model and the visual generative model in a tightly integrated pipeline.

In another embodiment, the server can store multiple generative AI models for different individuals and dynamically select an appropriate model instance based on a user selection at the terminal. The server can also support incremental training, in which newly acquired behavior information is periodically used to update the numerical feature quantities and refine the model parameters, thereby improving accuracy over time. The server may further implement load balancing and model caching strategies to serve multiple users concurrently while maintaining response times within a predefined threshold.

Through these embodiments, the server, the terminal, and the user cooperate to realize a system that transforms raw image information and behavior information into personalized dialogue text and synchronized audiovisual content by means of defined data structures, processing modules, and neural network architectures. This results in improved processing speed, accuracy of style reproduction, synchronization quality, and resource utilization within the computer system, thereby improving the functioning of the computer itself.

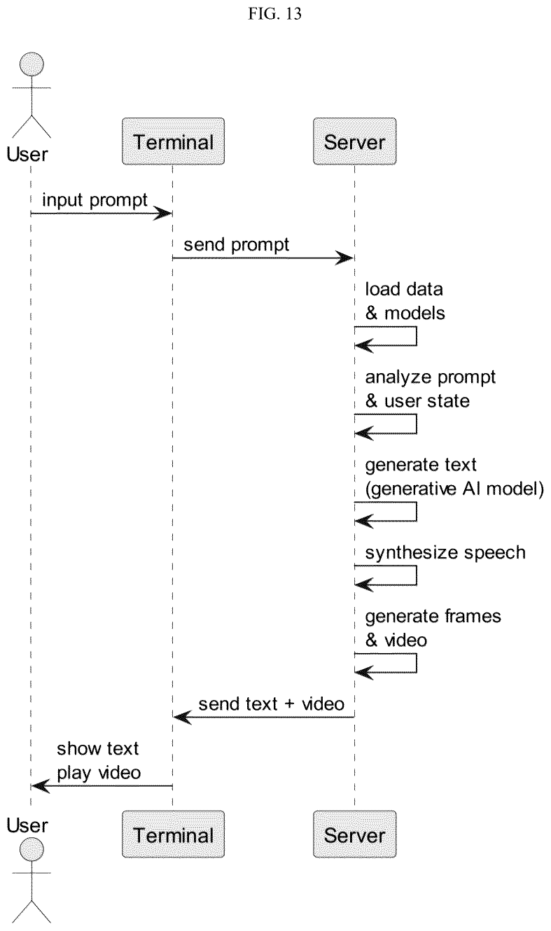

The following describes the processing flow using FIG. 13.

### Step 1

The server acquires individual-related data from multiple sources. The server receives as input authentication information and an individual identifier, and, based on this input, the server connects via a communication interface to mail servers, message archives, social platforms, and storage services. The server retrieves behavior information (text logs, posts, messages, browsing histories) and image information (photos, videos) and writes these items into an external storage device. The server converts heterogeneous formats (for example, JSON, HTML, image files, video files) into internal records and outputs a unified raw data set indexed by the individual identifier.

### Step 2

The server preprocesses text information included in the behavior information. The server takes as input raw text records from the unified data set and applies a natural language processing program. The server removes unwanted substrings such as markup tags, URLs, signatures, and system notifications by applying pattern-matching rules and filters, and normalizes character encoding and case. The server then segments each text record into sentences and words, assigns grammatical information (such as part-of-speech tags and dependency relations) and emotion information (such as sentiment labels) using language models, and outputs structured preprocessed data in which each sentence is represented as a sequence of tokens with attached annotations.

### Step 3

The server extracts numerical feature quantities representing thought patterns and language characteristics. The server uses the preprocessed data as input and generates statistical and machine-learned representations. The server computes word and phrase frequencies, constructs n-gram models, and projects sentences into vector spaces using embedding techniques. The server performs clustering or topic modeling to identify topic tendencies and correlates topics with emotion labels to obtain emotion tendencies. By aggregating these computed values per individual, the server outputs a set of numerical feature quantities, including vectors for vocabulary distribution, style patterns, topic tendencies, and emotion tendencies.

### Step 4

The server configures and trains a generative AI model as a generative language processing model. The server receives as input the numerical feature quantities and training examples constructed from historical dialogues (context text and response text). The server initializes a neural network architecture with multiple attention layers and feed-forward layers and then fine-tunes the network parameters using a loss function such as cross-entropy on predicted tokens. The server updates weights by backpropagating gradients using an optimization algorithm and iterates training until validation metrics converge. The server outputs a trained generative AI model instance and associated generation parameters that encode the individual's thought patterns and language characteristics.

### Step 5

The terminal collects a prompt sentence from the user and sends it to the server. The user inputs, as input, a natural language prompt sentence through a text field or voice input on the terminal, such as “Please recreate a scene where the deceased thanks a close friend for long-lasting support.” The terminal converts any voice input to text, attaches session information and user identifiers, and outputs a request message containing the prompt sentence. The terminal transmits this request to the server via a secure communication protocol.

### Step 6

The server analyzes the prompt sentence and constructs context information. The server takes as input the received prompt sentence and associated user and individual identifiers. The server applies an instruction parser to detect scene, topic, conversational atmosphere, and emotional tone specified in the prompt sentence. The server maps detected elements to numerical control variables and selects or weights relevant numerical feature quantities (such as specific vocabulary distributions and style patterns) from the feature store. The server then combines the prompt sentence tokens, control variables, and feature vectors into a structured context representation, and outputs this context information for use by the generative AI model.

### Step 7

The server performs emotion analysis on user-provided information and adjusts generation parameters. The server uses as input either text information typed by the user or voice information captured and transmitted by the terminal. For voice information, the server extracts acoustic features and runs an emotion classifier; for text information, the server applies a text-based emotion classifier. The server fuses the results to identify an emotion state such as “stressed” or “relieved.” The server then uses this emotion state to modify a parameter vector that controls style and tone in the generative AI model, for example by altering weighting of comforting versus neutral expressions. The server outputs updated generation parameters that are conditioned on the current emotion state.

### Step 8

The server generates dialogue text using the generative AI model. The server takes as input the structured context information and the updated generation parameters. The server tokenizes the prompt sentence, injects control tokens representing scene, topic, and emotion, and feeds these along with the numerical feature quantities into the generative AI model. The server executes a decoding algorithm (such as sampling with temperature or top-k constraints) to compute a sequence of output tokens. The server concatenates and detokenizes these tokens to form human-readable dialogue text that imitates the individual's language characteristics and responds to the prompt sentence. The server outputs this dialogue text to downstream modules and prepares a response message for the terminal.

### Step 9

The server processes image information and extracts facial feature quantities. The server receives as input image information (photos and frames from videos) associated with the individual from the unified data set. The server uses an image processing program to detect face regions and facial landmarks and applies a facial feature extraction algorithm to compute facial shape information (such as landmark coordinates and geometric relationships) and expression information (such as smiling or speaking-related mouth shapes). The server stores these as numerical feature quantities indexed by image and individual identifiers and outputs a facial feature set for use in visual generation.

### Step 10

The server performs speech synthesis for the generated dialogue text. The server takes the dialogue text as input and applies a speech synthesis pipeline that includes text analysis, phoneme conversion, prosody prediction, and waveform generation. The server computes a sequence of phonemes with timing and prosodic parameters and then generates an audio waveform that represents voice information corresponding to the dialogue text. The server outputs both the synthesized voice information and aligned phoneme and timing information as a synchronized audio representation.

### Step 11

The server generates a sequence of image frames to form an audio-attached moving image. The server uses as input the facial feature set, the phoneme and timing information, and optionally the dialogue text. The server applies a generative model for visual information generation that maps the phoneme sequence and facial features to per-frame facial geometry and texture updates. The server computes, for each time step aligned to the phoneme timing, an image frame that shows the individual's face with appropriate mouth shape and expression. The server encodes the sequence of image frames as a video stream and multiplexes the video stream with the synthesized audio waveform to produce an audio-attached moving image. The server outputs a media file or streaming data structure that can be rendered by the terminal.

### Step 12

The server sends generated content to the terminal, and the terminal presents it to the user. The server receives as input a request for delivery from the application layer and selects the corresponding dialogue text and audio-attached moving image. The server packages these as response payloads, possibly including metadata such as duration and resolution, and transmits them through the communication interface. The terminal receives the dialogue text and media data as input, stores them temporarily in local memory, decodes the video and audio streams using its media subsystem, and displays the dialogue text and plays back the audio-attached moving image on the display and speakers. The user perceives output in which the dialogue text and visual representation are synchronized and tailored to the prompt sentence and emotion state.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialogue systems and avatar systems that attempt to reproduce a deceased person primarily replay static recordings or generate generic responses based on limited profile data. Such systems suffer from several technical deficiencies. First, they typically do not construct a persistent, machine-interpretable representation of the deceased person's thought patterns and linguistic style derived from large volumes of historical behavioral data. As a result, the generated responses are not consistently conditioned on the deceased person's actual response tendencies and do not maintain coherence across multiple dialogue turns. Second, existing systems usually treat emotion recognition as an auxiliary feature and do not deeply integrate the user's real-time emotional state into the generation pipeline and avatar-control pipeline. This leads to a disconnect between the user's emotional context and both the generated content and the visual behavior of a digital avatar. Third, many systems invoke a generative AI model in an ad-hoc manner, with prompt sentences that are handcrafted and static, without systematic, dynamic construction from structured style, thought-pattern, and emotion information. This results in inefficient use of generative AI capabilities, limited controllability of outputs, and inconsistent user experiences. Fourth, traditional avatar systems often drive three-dimensional models using fixed scripts or precomputed animations, rather than synchronizing speech synthesis, facial expression control, and body motion control to dialog content and user emotion in real time. Consequently, the user experiences a technically constrained, low-immersion interaction that fails to reflect both the deceased person's individualized characteristics and the user's changing emotional state.

There is therefore a need for a computer-implemented system that improves the way processors acquire, preprocess, and structure multimodal data about a deceased person; that dynamically constructs prompt sentences for a generative AI model based on machine-readable style information, thought-pattern information, user emotion, and dialogue context; and that tightly couples the generative AI output with synchronized speech synthesis and three-dimensional avatar control. Such a system should provide a technically enhanced pipeline for managing dialogue history, generating emotionally adaptive responses, and rendering synchronized audiovisual representations in two-dimensional or virtual-reality environments. By doing so, the system should improve computer functionality in the domains of natural language generation, emotion-aware adaptive content control, and real-time three-dimensional rendering, rather than merely automating a mental or human activity.

The specific processing by the specific processing unit 290 of the data processing device 12 in Application Example 2 is realized by the following means.

The present invention provides a server comprising a processor configured to acquire visual information and behavioral information related to a deceased person from storage or from a communication interface, to perform preprocessing on the visual information and the behavioral information, and to extract features from the preprocessed information; to analyze thought patterns and linguistic styles of the deceased person by applying natural language processing to the extracted behavioral features, to model response tendencies on a dialogue-turn basis, and to structure and store the modeled response tendencies as style information and thought-pattern information in a data repository; to extract facial feature points from the visual information of the deceased person by applying image processing, and to generate and store appearance information including three-dimensional shape information and expression-deformation information based on the facial feature points; to obtain audio information, image information, or character information from a user via an input interface, to execute emotion-analysis processing on the obtained information, and to specify emotion information indicating an emotional state of the user; to dynamically construct a prompt sentence for input to a generative artificial intelligence model based on the style information, the thought-pattern information, the emotion information, latest utterance content of the user, and dialogue history managed in a session context; to input the prompt sentence into the generative artificial intelligence model via a programmatic interface, to cause the generative artificial intelligence model to generate dialogue text representing speech of the deceased person reflecting the style information and the thought-pattern information, and to update the dialogue history with the generated dialogue text; to execute speech-synthesis processing based on the generated dialogue text to generate an audio signal, to control expression parameters and motion parameters of the three-dimensional shape information of the deceased person based on the appearance information and the emotion information to generate a visual representation of the deceased person, and to generate output data as video synchronized with the audio signal; and to transmit the output data to a user terminal to cause display and playback of the output data and to continue dialogue with the user. This enables a technically improved, end-to-end computer-implemented pipeline that unifies multimodal feature extraction, structured representation of style and thought patterns, dynamic prompt sentence construction for a generative AI model, emotion-aware dialogue generation, and real-time three-dimensional avatar control, thereby enhancing the quality, coherence, and emotional adaptivity of the interactive experience beyond what is achievable with conventional systems.

The term “visual information” refers to image data or video data representing an appearance of a person, including but not limited to face images, body images, or other pictorial representations encoded in a digital format.

The term “behavioral information” refers to electronic records of actions or activities of a person in a digital environment, including but not limited to messages, posts, logs, browsing histories, or other interaction histories stored in a data storage.

The term “deceased person” refers to an individual who has died and whose past visual information and behavioral information are processed by the system to simulate dialogue and appearance.

The term “preprocessing” refers to a set of computational operations applied to raw data to normalize, clean, structure, or otherwise transform the data into a form suitable for subsequent analysis, including operations such as noise removal, segmentation, tokenization, and format conversion.

The term “feature” refers to a numerical value, symbol, or structured element extracted from raw data that characterizes a property of the data, such as a statistical measure, a linguistic attribute, or a geometric descriptor.

The term “thought patterns” refers to machine-interpretable representations of inferred tendencies in how a person responds or reasons in particular conversational or situational contexts, derived from analysis of sequences of behavioral information.

The term “linguistic styles” refers to machine-interpretable representations of characteristic ways in which a person uses language, including preferred words, phrases, sentence structures, levels of formality, and recurrent emotional tones.

The term “natural language processing” refers to computational techniques for analyzing, understanding, or generating human language, including operations such as tokenization, part-of-speech tagging, parsing, named-entity recognition, topic modeling, and sentiment analysis.

The term “dialogue-turn basis” refers to a representation or analysis unit that treats each exchange in a conversation, including a user utterance and a corresponding system response, as a discrete turn for modeling response tendencies.

The term “style information” refers to stored data structures encoding linguistic styles of a person, including typical expressions, topic preferences, writing patterns, and emotional tones, which are used to condition generation of dialogue.

The term “thought-pattern information” refers to stored data structures encoding thought patterns of a person, including mappings from input situations or user states to characteristic types of responses, which are used to influence dialogue generation.

The term “image processing” refers to computational operations performed on visual information to detect, segment, transform, or analyze visual content, including but not limited to face detection, feature-point detection, and geometric normalization.

The term “facial feature points” refers to specific locations on a face detected by image processing, such as eye corners, nose tip, mouth corners, and points along a jawline, which are used to construct or deform a facial model.

The term “appearance information” refers to data describing an external appearance of a person, including three-dimensional shape information and expression-deformation information that define a digital representation of the person's face and body. The term “three-dimensional shape information” refers to data describing a geometric structure of an object in three-dimensional space, including coordinates of vertices, mesh connectivity, or similar geometric representations for a digital model.

The term “expression-deformation information” refers to parameters or data that define how a three-dimensional shape is altered to represent different facial expressions, such as smiling, frowning, or eye blinking, including but not limited to blend-shape weights.

The term “audio information” refers to digital data representing sound, including speech signals or other acoustic data obtained from a user or generated by the system.

The term “image information” refers to visual data such as still images or frames from a video representing a user or other objects, which may be used for emotion analysis or display. The term “character information” refers to textual data composed of character strings input by a user or generated by the system, representing natural language content.

The term “emotion-analysis processing” refers to computational operations that infer an emotional state from input data, such as audio information, image information, or character information, using pattern recognition or machine-learning techniques.

The term “emotion information” refers to a data representation of an inferred emotional state of a user, including one or more emotion categories, such as sadness, joy, or calmness, and optionally associated confidence values.

The term “prompt sentence” refers to a text sequence provided as input to a generative artificial intelligence model, the text sequence containing instructions, context, and conditions that guide the model to generate a desired output.

The term “generative artificial intelligence model” refers to a trained computational model configured to generate new data, such as natural language text, conditioned on input data including a prompt sentence and additional context.

The term “dialogue history” refers to stored records of prior exchanges between a user and the system, including user utterances and system outputs, which are used as context for subsequent dialogue generation.

The term “session context” refers to state information associated with an ongoing interaction instance, including dialogue history, emotion information, style information, thought-pattern information, and other parameters relevant to that interaction.

The term “dialogue text” refers to natural language text representing a system-generated utterance, which simulates speech of the deceased person in response to a user input.

The term “speech-synthesis processing” refers to computational operations that convert dialogue text into an audio signal representing synthesized speech.

The term “audio signal” refers to a time-varying digital representation of sound generated by speech-synthesis processing and suitable for playback by an audio output device.

The term “expression parameters” refers to control values applied to a three-dimensional model to change visual aspects of a face, such as eye openness, mouth shape, or eyebrow positions, to represent different expressions.

The term “motion parameters” refers to control values applied to a three-dimensional model to change pose or movement, such as position, rotation, or joint angles of body parts. The term “visual representation” refers to a rendered visual depiction of a digital model, such as an image sequence or frames of an animation, that is suitable for display to a user.

The term “output data” refers to digital data generated for presentation to a user, including synchronized combinations of video data and audio data, or parameters for rendering such combinations.

The term “user terminal” refers to an electronic device operated by a user, such as a computing device with a display and input interfaces, configured to communicate with the server, receive output data, and present the output data.

The term “virtual space” refers to a computer-generated three-dimensional environment in which digital objects, including three-dimensional shape information representing an avatar, can be placed and rendered.

The term “position” refers to spatial coordinates assigned to a digital object or three-dimensional model within a virtual space.

The term “posture” refers to an orientation or pose of a digital object or three-dimensional model, including orientation of a head, torso, or limbs relative to a reference frame.

The term “gaze direction” refers to an orientation of virtual eyes or head of a three-dimensional model indicating a direction toward which the model appears to look.

The term “facial expression” refers to a combination of face-related expression parameters applied to a three-dimensional model to represent an emotional state, such as a smile, frown, or neutral expression.

The term “immersive dialogue experience” refers to an interaction in which a user perceives a high degree of presence and realism, due to synchronized audiovisual output and responsive behavior of a virtual representation in a two-dimensional or three-dimensional environment. The term “virtual reality environment” refers to an interactive, computer-generated environment that presents a virtual space with which a user can interact, typically through a head-mounted display or similar device, and within which three-dimensional models and dialogue can be presented.

In one embodiment, a server cooperates with at least one terminal operated by a user to implement the claimed system. The server includes at least one processor, a main memory, non-volatile storage, and a network interface. The terminal includes a processor, a display, an audio input device, an audio output device, a camera, and a communication interface. The server and the terminal communicate via a digital communication network using a transport protocol such as HTTPS or a bidirectional protocol such as WebSocket.

The server stores program code in the non-volatile storage. The program code, when executed by the processor of the server, causes the server to implement modules including a data acquisition module, a preprocessing module, a natural language processing module, a feature-extraction module, a model construction module, a prompt-construction module, a generative AI interface module, a speech-synthesis module, an avatar-control module, an emotion-analysis interface module, a session-management module, and a rendering/output module. The server stores these modules as executable instructions that operate on structured data in the main memory.

The server acquires visual information and behavioral information related to a deceased person. The server receives visual information such as still images or video frames of the deceased person from the terminal, and also retrieves visual information from a storage subsystem. The server uses an image-processing library such as an open-source computer vision library or a commercial vision toolkit to decode the visual information into pixel matrices. The server acquires behavioral information including logs of text messages, social communication records, documents, and other electronic activity records from a storage service or from uploaded files. The server stores these behavioral records in structured data containers such as relational tables or document collections.

The server performs preprocessing on the acquired behavioral information to normalize and structure the data. The server uses a data-analysis library such as a tabular-data analysis toolkit to load behavioral information into in-memory tables, with fields including timestamps, author identifiers, and text content. The server converts all text into a standard character encoding, removes control characters and markup, and segments the text into individual utterances and sentences. The server stores each utterance as a separate record associated with contextual metadata, thereby creating a structured corpus of the deceased person's historical language use.

The server applies natural language processing to this structured corpus. The server uses a natural language processing library such as a tokenization and parsing toolkit to perform tokenization, part-of-speech tagging, syntactic parsing, and named-entity recognition on each utterance. The server computes numeric feature vectors for each utterance, including word-frequency vectors (for example, term frequency-inverse document frequency), sentence-length statistics, part-of-speech distributions, and sentiment scores. The server applies topic modeling algorithms such as latent Dirichlet allocation implemented in a machine-learning framework to cluster utterances into topics. The server stores this topic information as part of a style profile.

The server constructs thought-pattern information by analyzing sequences of utterances. The server defines a dialogue-turn data structure that links a user input and an associated reply by the deceased person, when such sequences are available in historical logs. The server trains a sequence model, such as a recurrent neural network or a transformer-based network, using these dialogue-turn sequences as training data. In one embodiment, the server constructs an encoder-decoder architecture where an encoder transforms the input-utterance vector into a context embedding, and a decoder predicts a representation of the reply-utterance vector. The server uses an objective function such as cross-entropy loss over predicted tokens or a contrastive loss over semantic embeddings. The server updates network weights using a gradient-descent-based optimizer such as stochastic gradient descent, adaptive moment estimation, or a variant thereof. The server executes this training process offline and stores the resulting model parameters as thought-pattern information for the deceased person. The server extracts linguistic styles from the corpus by aggregating statistics across the utterances produced by the deceased person. The server identifies high-frequency n-grams, typical sentence openings, and characteristic expressions. The server computes distributions over sentiment labels and formality scores, and stores these distributions as style information. The server maintains the style information in a structured form such as a dictionary of expressions, a set of numerical distributions, and one or more dense embedding vectors that represent style dimensions.

The server performs image processing on the visual information to obtain appearance information. The server uses a face-detection algorithm, such as a cascaded classifier or a convolutional neural network-based detector, to locate face regions in each image or frame. The server uses a facial landmark detector, such as an ensemble of regression trees or a deep landmark network, to identify facial feature points including eye corners, nose tip, mouth corners, and points along the jawline. The server normalizes the coordinates of these feature points to a canonical coordinate system. The server stores these normalized facial feature points as facial feature data.

The server generates three-dimensional shape information by mapping the facial feature data onto a parameterized three-dimensional mesh. In one embodiment, the server uses a 3D modeling application programming interface, such as that provided by a three-dimensional content creation tool, to deform a generic head mesh according to the measured facial feature points. The server adjusts parameters such as scale, rotation, and vertex offsets so that the deformed mesh approximates the deceased person's facial geometry. The server also creates expression-deformation information, such as blend-shape targets or skeletal animation parameters, that can be used to represent different facial expressions. The server exports and stores this three-dimensional shape information and expression-deformation information as appearance information in a storage subsystem.

The server analyzes a user's emotional state by receiving user audio information, image information, or character information from the terminal. The terminal captures the user's face image using the camera and the user's voice using the microphone and transmits digital audio samples and video frames to the server. Alternatively, the terminal transmits text messages entered by the user. The server applies an emotion-analysis model, which may include a convolutional neural network for facial expression classification or a recurrent neural network for audio-based emotion classification, trained on emotion-labeled datasets. The server computes feature vectors from the user's audio and image information and applies the classifier to infer one or more emotion categories with associated probabilities. For text, the server applies sentiment-analysis techniques using a neural network trained to classify emotional tone based on linguistic features. The server stores this result as emotion information that indicates the current emotional state of the user.

The server manages a session context for each active interaction. The server creates a session record that maintains a dialogue history, the most recent emotion information, references to style information and thought-pattern information for the deceased person, and identifiers of the appearance information. The server updates this session context after each user interaction and after each system-generated reply.

The server constructs a prompt sentence for a generative AI model by combining multiple elements from the session context. The server selects a prompt template based on the type of interaction, such as a comforting conversation, factual recall, or storytelling. The server inserts values into the template including the style information (for example, typical expressions and topics), the thought-pattern information (for example, tendencies to provide reassurance), the user's latest utterance text, and the current emotion information. The server constructs a dense text prompt that instructs the generative AI model to generate a short reply that reflects the deceased person's style and thought patterns and that responds appropriately to the user's emotional state.

For example, the server may construct a prompt sentence as follows:

“You are a generative AI model simulating the deceased grandfather. His style is warm, slightly humorous, and he often says ‘I'm always watching over you.’ The user just said: ‘I really miss you today.’ The user's current emotion is sad. Using his thought patterns (he usually reassures family members and shares a short memory from a past trip), generate a short, comforting reply in his own words.”

In another example, when the user requests a specific memory, the server may construct a prompt sentence as follows:

“In the style of the deceased grandfather who loved poetry, generate a brief introduction line he might say before reading his favorite poem ‘Invictus.’ Keep his tone warm and nostalgic, and then transition naturally into the poem.”

The server communicates with a generative AI model via an application programming interface. The generative AI model may be implemented as a large-scale neural network language model, such as a transformer network with multiple layers of self-attention and feedforward sublayers. The model has been pre-trained on large corpora of text using an unsupervised objective such as predicting next tokens, and optionally fine-tuned using dialogue-oriented datasets with reinforcement-learning-based preference optimization. The server sends the constructed prompt sentence and optional control parameters, such as maximum output length and sampling temperature, to the generative AI model. The generative AI model returns dialogue text representing a candidate reply.

The server post-processes this dialogue text. The server may apply filters to remove inappropriate content, enforce length constraints, or insert punctuation normalization. The server appends the generated dialogue text to the dialogue history in the session context. The server thus maintains a persistent record of system-generated replies and user inputs, enabling subsequent prompt sentences to incorporate the dialogue history for improved coherence. The server performs speech-synthesis processing on the generated dialogue text. The server employs a text-to-speech pipeline that converts the text into phoneme sequences, applies a neural vocoder or a parametric synthesis module to produce an audio signal, and optionally adjusts prosody parameters, such as pitch and speaking rate, based on style information and emotion information. The server produces an audio signal that approximates a consistent speaking style, and in some embodiments approximates the deceased person's voice characteristics if suitable voice data and a trained voice conversion model are available. The server controls the three-dimensional shape information of the deceased person based on the appearance information and emotion information. The server maps phoneme timings from the speech-synthesis pipeline to viseme parameters or mouth-shape blend-shape weights in the three-dimensional model. The server applies expression-deformation information to adjust facial expressions in accordance with the user's emotional state; for example, the server applies a gentle, sympathetic expression when the emotion information indicates sadness, or a brighter, animated expression when the emotion information indicates joy. The server also adjusts motion parameters such as head tilt, gaze direction, or body posture to align the avatar's behavior with the conversational content and emotional context. The server integrates the audio signal and the visual representation into synchronized output data. The server generates a stream of animation frames from the three-dimensional model using a rendering engine, such as a real-time graphics engine. The server synchronizes each animation frame with an appropriate segment of the audio signal using timestamps derived from the speech-synthesis process. The server may encode the resulting audiovisual stream as a compressed video file, or may stream the audio and animation parameters separately to the terminal for local rendering.

The terminal receives the output data from the server and displays and plays back the output data. In a two-dimensional embodiment, the terminal decodes the video stream and renders it on the display, while outputting the synchronized audio through speakers or headphones. In a three-dimensional or virtual-reality embodiment, the terminal runs a locally installed rendering engine, loads the three-dimensional model and animation parameters, and renders the avatar and a virtual space according to the motion and expression parameters transmitted by the server. The terminal allows the user to see and hear the deceased person's avatar speaking in apparent real time.

The user interacts with the system by speaking into the microphone, typing text on the terminal, or moving within a virtual-reality environment. The user's audio, video, and text data are captured by the terminal and transmitted to the server according to the communication protocol. The user's actions can influence the avatar's position and gaze within the virtual space. The server uses such input signals, along with emotion information, to update control signals for the avatar, causing the avatar to orient toward the user, adjust distance, or change gesture patterns.

This configuration achieves a number of technical improvements. The server's structuring of behavioral information into style information and thought-pattern information provides a machine-interpretable representation that enables the generative AI model to be consistently conditioned, thereby improving coherence and personalization of generated dialogue compared to ad-hoc prompt design. Because the server maintains structured style information and thought-pattern information separately from momentary prompts, the server can re-use these profiles efficiently, reducing repeated computation and improving processing speed.

The server's emotion-aware integration pipeline uses emotion information not merely for display but as an input to both prompt sentence construction and avatar control. This dual use of emotion information yields a technical effect on the overall system: the generative AI model receives explicit signals about user emotion, which alters its output distribution in a predictable way, and the rendering engine receives matching expression parameters, which reduces mismatches between audio content and visual representation. This alignment reduces user confusion, improves perceived quality, and decreases the need for repeated corrections or manual adjustment.

The server's dynamic construction of prompt sentences according to templates and session context also improves computational efficiency. Instead of generating long, fully descriptive prompts from scratch for each request, the server reuses template structures and inserts only variable fields. This reduces network payloads, decreases latency in model invocation, and provides a consistent control interface to the generative AI model, which can improve generation stability and reduce variance in outputs.

The server's three-dimensional control scheme, which uses phoneme timing and emotion information to drive separate channels of avatar motion (lip-sync, facial expression, head movement, gaze), improves rendering quality and reduces artifacts such as asynchronous speech and expression. This yields a system-level technical benefit that cannot be achieved by simple replay of pre-recorded video, because the avatar responses are generated and rendered in real time and adapt dynamically to the content and emotion context.

The use of neural-network-based models within the server goes beyond simple automation of human mental tasks. The server uses specific network architectures and training strategies to implement mappings from large-scale historical data to compact style and thought-pattern representations, and then further uses these representations in a non-conventional procedural pipeline that links them with online emotion recognition and avatar control. The learning process relies on explicit objective functions, such as prediction error over next tokens or embeddings, and weight updates based on gradient backpropagation through network layers. The server also may perform data augmentation, such as paraphrasing or sampling negative examples, to improve robustness of the learned representations. These are not steps that a human could feasibly perform manually at scale, and they provide concrete improvements in prediction accuracy and dialogue appropriateness.

In another embodiment, the server reduces communication load by streaming only high-level animation parameters and audio data to the terminal, rather than full video frames. The terminal renders the avatar locally, applying the parameters sent by the server. This architecture reduces bandwidth requirements and enables higher frame rates on networks with limited capacity. The server thereby achieves a technical improvement in network usage and responsiveness compared to systems that must transmit full video streams for every interaction.

In yet another embodiment, the server uses multiple generative AI models, such as a primary large-scale language model for initial generation and a secondary, smaller model for post-filtering or style adjustment. The server combines outputs from these models using a rule-based or learned gating mechanism. This multi-model arrangement allows the server to reduce latency by using the smaller model for minor style corrections, while reserving the large-scale model for more complex generation. As a result, the system achieves a balance between response quality and processing time.

In a further embodiment, the server supports a virtual-reality environment. The server disposes the three-dimensional shape information of the deceased person within a virtual space that includes environmental objects and ambient audio. The server receives head-pose and controller data from a head-mounted display or motion tracking system attached to the terminal. The server adjusts the avatar's position, posture, gaze direction, and facial expression in response to the user's position and emotional state. The server thereby provides an immersive dialogue experience in which the user perceives the deceased person responding naturally within a three-dimensional environment.

These embodiments, and variations thereof, illustrate that the server, the terminal, and the user cooperate to realize a concrete technical system that improves the operation of computers in processing multimodal historical data, constructing structured representations, generating conditioned dialogue via a generative AI model, and controlling an audiovisual avatar in real time. The system thus provides more than an abstract idea; it implements specific data structures, algorithms, model architectures, and control flows that yield improved performance, responsiveness, and accuracy in a computer-implemented interactive environment.

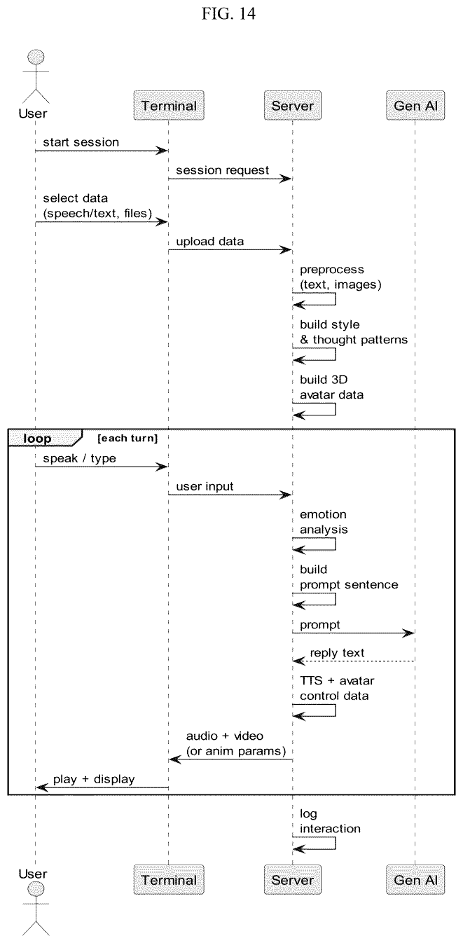

The following describes the processing flow using FIG. 14.

### Step 1

The user operates the terminal and selects an option to start an interaction with a deceased person.

The terminal displays a graphical user interface allowing the user to select files and grant permissions for camera and microphone access.

Input: User actions (menu selection, file selection, permission grants).

Output: A session-start request containing user identifiers, selected deceased-person profile identifiers (if any), and initial configuration parameters sent from the terminal to the server.

### Step 2

The terminal acquires visual information and behavioral information related to the deceased person.

The terminal allows the user to choose face photos, videos, and archived message logs stored on local storage or accessible cloud storage, and packages file paths or binary content.

Input: User-selected media files (images, videos) and data files (text logs, archives).

Output: A set of uploaded files and associated metadata transmitted to the server over a secure network connection.

### Step 3

The server receives the uploaded visual information and behavioral information from the terminal.

The server validates file types, checks for corruption, and registers each file in a storage index.

Input: Binary file streams and metadata describing file names, sizes, and types.

Output: Stored raw files in persistent storage and index records in a database that reference file locations and basic attributes.

### Step 4

The server preprocesses the behavioral information to generate a normalized text corpus.

The server decodes the uploaded data (for example, compressed archives), extracts text segments, converts encodings to a standard format, and segments messages into utterance units.

Input: Raw behavioral files (chat logs, email exports, social media archives).

Output: A structured corpus of utterance records, each including text content, timestamp, and optional counterpart identifiers, stored in a relational or document database.

### Step 5

The server performs natural language processing on the structured corpus to obtain linguistic features.

The server tokenizes each utterance, tags parts of speech, performs syntactic parsing, and identifies named entities using a language-processing library.

Input: Utterance records containing text fields from the corpus.

Output: Enriched utterance records that include token lists, part-of-speech tags, parse trees or dependency graphs, and entity annotations stored alongside the original text.

### Step 6

The server computes style-related statistics and constructs style information.

The server aggregates n-gram frequencies, sentence length distributions, sentiment scores, and topic assignment probabilities over all utterances authored by the deceased person.

Input: Enriched utterance records with linguistic annotations and sentiment labels.

Output: Style information structures, including lists of typical expressions, topic profiles, sentiment distributions, and numeric style embeddings representing the deceased person's linguistic style.

### Step 7

The server derives thought-pattern information by analyzing response tendencies across dialogue turns.

The server identifies pairs or sequences of user messages and corresponding replies by the deceased person, encodes these sequences as feature vectors, and trains a sequence model such as a recurrent neural network or transformer encoder-decoder.

Input: Linked dialogue-turn records formed from the corpus (input message, reply message), with their feature representations.

Output: Thought-pattern information comprising trained model parameters and mappings from input contexts to latent representation vectors that describe typical response tendencies.

### Step 8

The server preprocesses the visual information of the deceased person to obtain facial feature data.

The server decodes each image or video frame into a pixel array, detects one or more faces, and applies a facial landmark detector to locate key facial points.

Input: Raw image and video frames representing the deceased person's face or upper body.

Output: Facial feature point sets for each processed image or frame, normalized to a canonical coordinate system and stored as feature arrays.

### Step 9

The server generates three-dimensional shape information and expression-deformation information based on the facial feature point sets.

The server maps the feature points onto a generic parametric head mesh, adjusts vertex positions to fit the deceased person's facial geometry, and defines or refines blend-shape targets representing different expressions.

Input: Normalized facial feature point sets and a generic three-dimensional head model.

Output: Appearance information including a customized three-dimensional head (and optionally torso) mesh and associated expression-deformation parameters stored as 3D asset files and metadata.

### Step 10

The server registers the appearance information and style/thought-pattern information into a profile for the deceased person.

The server creates a profile record referencing the stored three-dimensional shape information, expression-deformation information, style information, and thought-pattern information and links this profile to the current user session.

Input: Appearance information, style information, and thought-pattern information objects.

Output: A deceased-person profile entry in a database with identifiers used for subsequent retrieval during dialogue.

### Step 11

The terminal captures user input during an interaction.

The terminal records the user's spoken utterance via the microphone, captures one or more video frames via the camera, or collects text typed into a text field, and timestamps these data.

Input: User speech, facial expressions, gestures within view of the camera, and typed text.

Output: Encoded audio samples, video frames, or text strings transmitted to the server as interaction input.

### Step 12

The server performs emotion-analysis processing on the user input to determine emotion information.

The server extracts acoustic features such as pitch, energy, and spectral coefficients from the audio, extracts facial features from the video frames, and/or computes text-based sentiment features, then applies trained emotion classifiers to estimate emotion categories and confidence values.

Input: Encoded audio samples, video frames, and/or text strings representing the user's current input.

Output: Emotion information specifying one or more emotion labels (for example, sadness, joy, calmness) and associated probability scores stored in the session context.

### Step 13

The server updates the session context with the latest user utterance and emotion information.

The server appends the user's transcribed utterance to the dialogue history list, updates the current emotion state in the session record, and optionally computes derived context flags such as “comforting response required.”

Input: User utterance text (or transcribed speech) and emotion information.

Output: An updated session context structure reflecting the extended dialogue history and current emotion state.

### Step 14

The server selects a prompt template based on the session context.

The server examines the emotion information, dialogue history length, and interaction mode (for example, casual chat, memory recall) and chooses a corresponding template category, such as “comforting reply” or “reminiscence about travel.”

Input: Session context including emotion state and conversation metadata.

Output: A selected prompt-template structure with slots for style information, thought-pattern information, user utterance content, and emotion labels.

### Step 15

The server constructs a concrete prompt sentence for a generative AI model by filling the selected template.

The server inserts typical expressions, topic preferences, and style descriptors from the style information; inserts relevant response-tendency descriptions from the thought-pattern information; inserts the user's latest utterance text; and includes an explicit indication of the user's current emotion.

Input: Selected prompt template, style information, thought-pattern information, latest user utterance text, and emotion information.

Output: A fully formed prompt sentence text string ready to be transmitted to the generative AI model.

### Step 16

The server invokes the generative AI model using the constructed prompt sentence.

The server sends an API request containing the prompt sentence and generation parameters such as maximum token length and temperature to a transformer-based language model hosted locally or remotely.

Input: Prompt sentence and generation control parameters.

Output: Dialogue text generated by the generative AI model, representing a reply in the style of the deceased person and conditioned on the supplied context.

### Step 17

The server post-processes the generated dialogue text and updates the dialogue history.

The server trims overly long replies, normalizes punctuation, filters prohibited content based on safety rules, and appends the sanitized reply as a system utterance in the dialogue history. Input: Raw generated dialogue text from the generative AI model and the existing dialogue history.

Output: A cleaned dialogue reply and an updated dialogue history list stored in the session context.

### Step 18

The server performs speech-synthesis processing on the generated dialogue text to produce an audio signal.

The server converts the text into phoneme sequences, applies a neural text-to-speech synthesizer or a parametric synthesis engine, and generates a waveform that reflects desired prosodic characteristics such as pitch contour and speech rate adapted to the style information and emotion information.

Input: Generated dialogue text and style/emotion parameters.

Output: An audio signal file or stream (for example, PCM samples or compressed audio) representing synthesized speech aligned with a phoneme timing map.

### Step 19

The server computes avatar control parameters for the three-dimensional model based on the audio signal and emotion information.

The server translates phoneme timing into viseme weights for lip-sync, selects facial expression parameters (for example, smiling, sympathetic, neutral) matching the user's emotion, and determines head and gaze motion trajectories that correspond to conversational emphasis.

Input: Phoneme timing data, emotion information, and appearance information (three-dimensional shape and expression-deformation parameters).

Output: A time-indexed sequence of avatar control parameters including viseme weights, expression intensities, and pose vectors.

### Step 20

The server generates output data that combine the avatar control parameters and the audio signal.

The server either renders video frames server-side using a graphics engine and encodes them into a video stream synchronized with the audio, or packages the avatar control parameters and audio into a structured data stream for client-side rendering.

Input: Avatar control parameter sequence and audio signal.

Output: Synchronized output data, in the form of encoded video and audio or in the form of audio plus animation parameters, ready for transmission to the terminal.

### Step 21

The server transmits the output data to the terminal over the communication network.

The server segments the output data into network packets, applies transport protocols with appropriate buffering and error handling, and sends the packets to the terminal identified by the session.

Input: Synchronized output data and terminal address/session identifiers.

Output: A stream of packets carrying audiovisual content or control parameters delivered to the terminal.

### Step 22

The terminal receives the output data and reconstructs audiovisual content.

The terminal decodes incoming packets, reassembles video frames and audio buffers, or applies avatar control parameters to a locally stored three-dimensional model using a rendering engine.

Input: Network packets containing output data.

Output: Rendered images of the avatar displayed on the screen and corresponding audio played through speakers or headphones.

### Step 23

The user observes and listens to the avatar and optionally continues the interaction.

The user perceives the synthesized voice and the three-dimensional representation of the deceased person speaking in coordination and may respond by speaking, typing, or performing actions in a virtual environment.

Input: Visual and auditory stimuli presented by the terminal.

Output: New user actions (speech, text, movements) that form the next cycle of interaction inputs to the terminal.

### Step 24

The server logs interaction data for subsequent analysis and system improvement.

The server stores tuples of user inputs, emotion information, constructed prompt sentences, generated dialogue texts, and avatar control patterns in a log database, and may periodically analyze these logs to refine style profiles or update prompt-template parameters.

Input: Session context snapshots and runtime interaction records.

Output: Persistent log records and updated model or template parameters used to improve future processing accuracy and efficiency.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

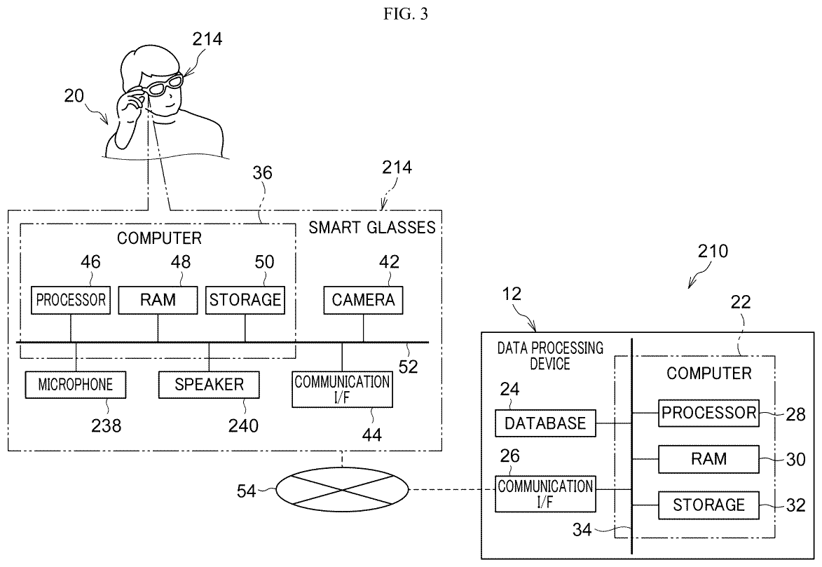

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

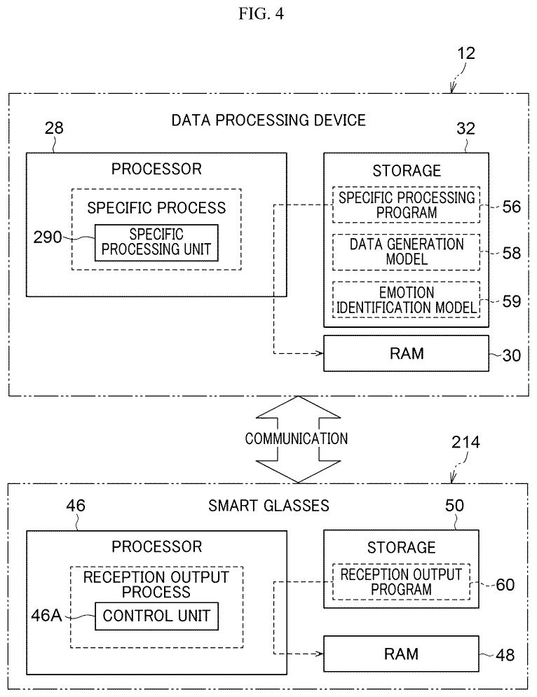

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

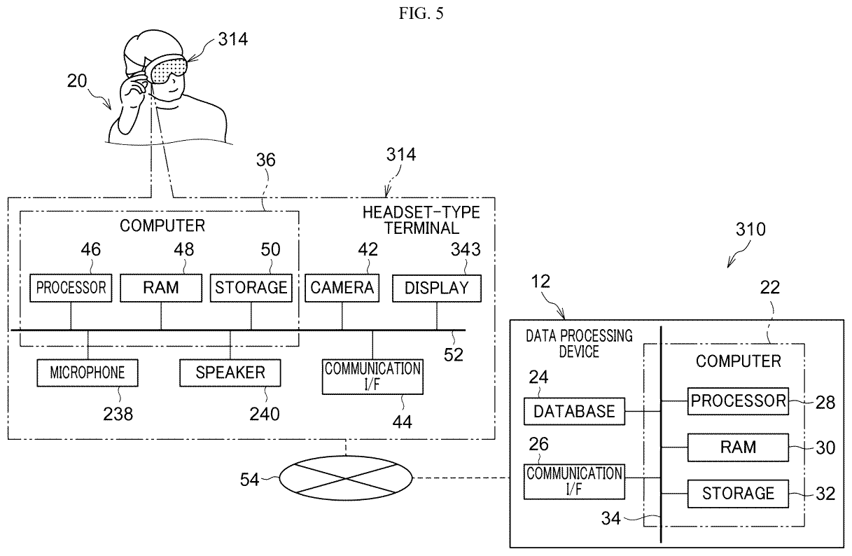

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

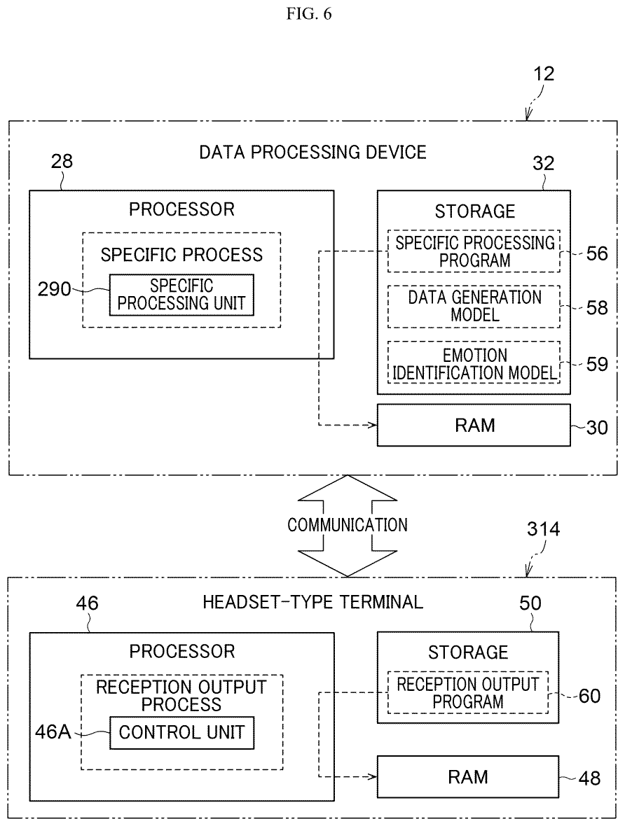

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

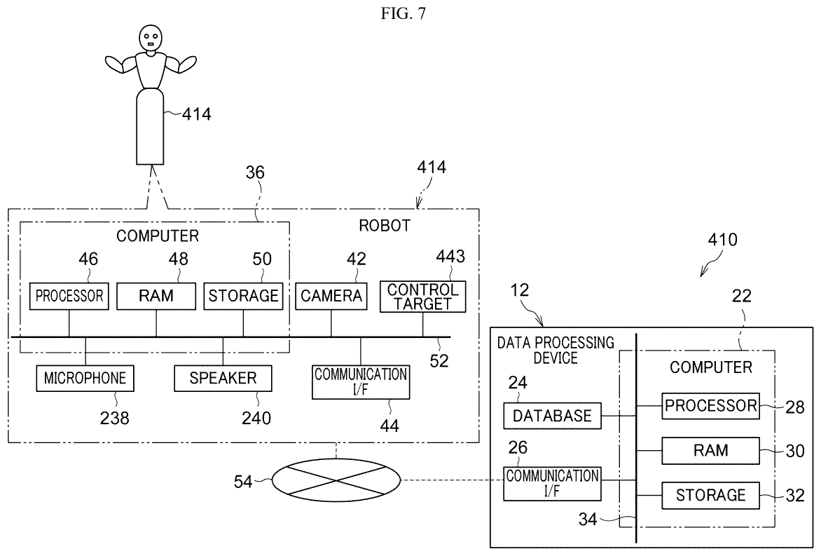

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

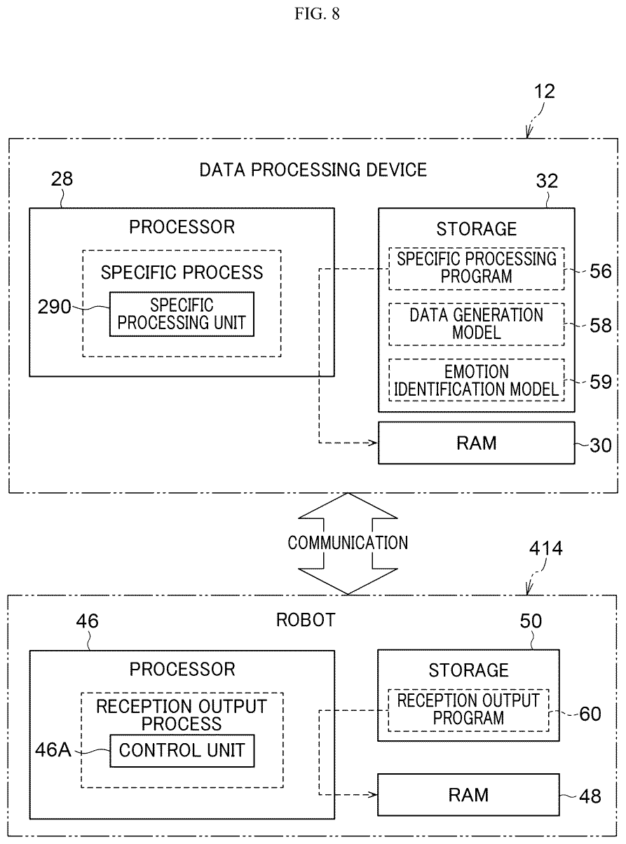

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

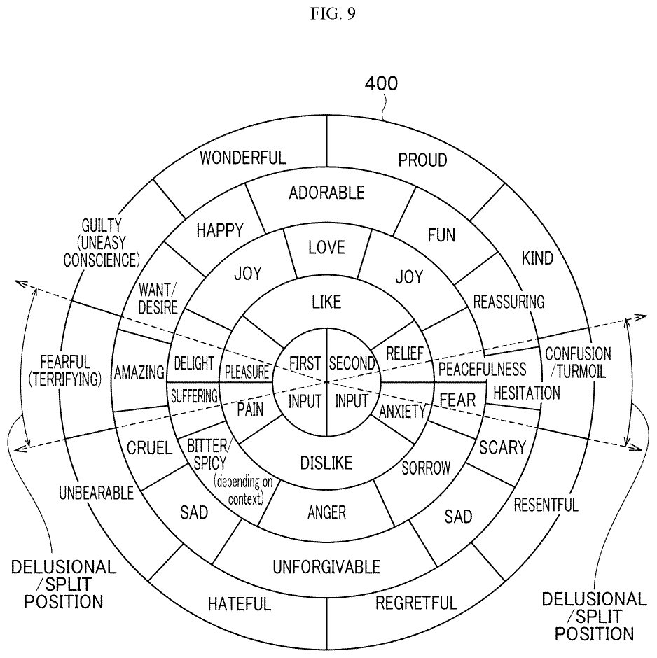

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

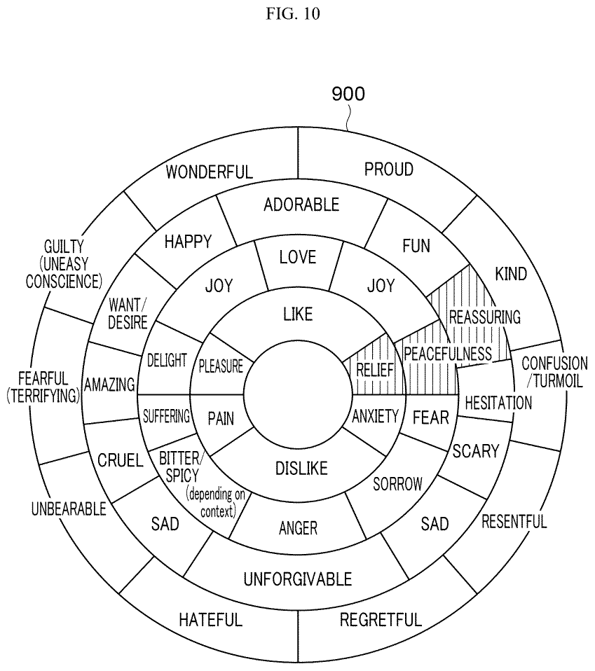

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, from a user terminal via a secure communication scheme, image information related to a memorized person and behavior history information related to the memorized person, perform preprocessing on the image information using image analysis resources to extract face region information and face feature information, perform preprocessing on the behavior history information using natural language processing resources to extract phrase sequence information and pragmatic feature information, and store the extracted information as structured information in an information management mechanism within a storage device, generate, on the basis of the structured information, a training data set representing thinking pattern information and language pattern information of the memorized person, train a text generation model and an image generation model as generative artificial intelligence models using machine learning resources so as to reproduce the thinking pattern information and the language pattern information of the memorized person, and store the trained generative artificial intelligence models in the storage device,
acquire prompt sentence information including instruction sentence information from the user terminal, input the prompt sentence information into at least one of the generative artificial intelligence models, and generate dialogue sentence information reflecting the thinking pattern information and the language pattern information of the memorized person, and transmit the dialogue sentence information to the user terminal,
generate, on the basis of the generated dialogue sentence information and the face feature information, moving image information or avatar image information of the memorized person using the image generation model and image processing resources, associate the moving image information or the avatar image information with the dialogue sentence information, and transmit the moving image information or the avatar image information to the user terminal, and
analyze voice information or text information acquired from a user to estimate emotional state information of the user, and, in accordance with the emotional state information, adjust at least part of output control conditions of the generative artificial intelligence models, vocabulary selection tendency information, and response pattern information so as to dynamically change the thinking pattern information and the language pattern information of the memorized person in the generated dialogue sentence information and moving image information.

### Supplementary 2

The system according to supplementary 1,
wherein the processor is configured to use vocabulary frequency information and collocation pattern information included in the structured information to identify gratitude expression information or characteristic expression information frequently used by the memorized person, assign weighting information to the identified gratitude expression information or characteristic expression information when training the generative artificial intelligence models, and cause the dialogue sentence information generated in response to the prompt sentence information to preferentially include the gratitude expression information or the characteristic expression information.

### Supplementary 3

The system according to supplementary 1,
wherein the processor is configured to input, into at least one of the generative artificial intelligence models, prompt sentence information that specifies generation of a message from the memorized person to a particular recipient category, and switch the vocabulary selection tendency information and style information of the dialogue sentence information in accordance with context information indicating the recipient category.

### Application Example 1

### Supplementary 1

A system comprising a processor,
wherein the processor is configured to
acquire image data and behavior history data related to a deceased person, normalize and structure the image data and the behavior history data, and store the normalized and structured data in a storage device,
preprocess text data included in the behavior history data by using a natural language processing function, extract feature quantities including token sequences, lexical statistics, emotional tendencies, and topic tendencies, and generate feature parameters representing a thinking pattern and a language style of the deceased person based on the feature quantities, train or adjust a generative language model based on the feature parameters and dialogue history data, and construct a generative AI model that imitates the thinking pattern and the language style of the deceased person,
acquire voice data of a user, convert the voice data into text data by using a speech recognition function, and estimate an emotional state of the user from the voice data and the text data by using an emotion recognition function,
generate a prompt sentence to be input to the generative AI model based on the dialogue history data, the text data, the emotional state, and the feature parameters, and dynamically generate a text response based on the thinking pattern and the language style of the deceased person by using the prompt sentence, and
generate audio data from the text response and voice feature parameters of the deceased person by using a speech synthesis function, and transmit the audio data to a user terminal for output.

### Supplementary 2

The system according to Supplementary 1,
wherein the processor is configured to
extract a face region from the image data related to the deceased person, generate a face embedding vector representing the face region by using a face feature extraction function, and generate video content in which a facial representation of the deceased person is synchronized with the audio data based on the face embedding vector and the text response.

### Supplementary 3

The system according to Supplementary 1,
wherein the processor is configured to
construct the prompt sentence to include context information obtained by summarizing latest utterance content of the user and past dialogue history, metadata indicating the thinking pattern and the language style of the deceased person, and instruction information specifying an emotional tone and a topic of the text response to be generated, and cause the generative AI model to generate an output having a predetermined expression style and content in accordance with the prompt sentence.

### Example 2

### Supplementary 1

A system comprising a processor,
wherein the processor is configured to
acquire, via an external storage device and a communication interface, image information related to a deceased person and behavior information on a communication network, and integrate the image information and the behavior information to store them as a data set, preprocess text information included in the acquired behavior information by using a natural language processing program to remove unnecessary information, segment the text information into sentence units and word units, and assign grammatical information and emotion information so as to structure the text information as preprocessed data,
extract, on the basis of the preprocessed data and by statistical processing or machine learning processing, numerical feature quantities representing frequently used expressions, style patterns, emotion tendencies, and topic tendencies of the deceased person, and model the numerical feature quantities as thought patterns and language characteristics of the deceased person,
determine generation parameters for generating dialogue text resembling the deceased person by training or configuring a generative language processing model on the basis of the modeled thought patterns and language characteristics of the deceased person,
receive, from a terminal operated by a user, a prompt sentence, and operate the generative language processing model on the basis of the prompt sentence and the generation parameters to generate dialogue text responding to the prompt sentence in a manner resembling the deceased person,
obtain voice information or text information from the user, perform emotion analysis processing on the obtained information to identify an emotion state of the user, and dynamically adjust the generation parameters relating to the thought patterns and the language characteristics of the deceased person in accordance with the identified emotion state so as to change vocabulary, style, and emotional expressions of the dialogue text, apply an image processing program and a facial feature extraction algorithm to the image information to extract facial shape information and expression information of the deceased person, and store the extracted facial shape information and expression information as numerical feature quantities,
generate a sequence of image frames expressing facial movements and expressions of the deceased person by using a generative model for visual information generation on the basis of the numerical feature quantities and the dialogue text, generate voice information corresponding to the dialogue text by performing speech synthesis processing, and time-synchronize the voice information with the sequence of image frames to generate output data as an audio-attached moving image, and
transmit the generated dialogue text and the audio-attached moving image to the terminal via the communication interface so that the dialogue text and the audio-attached moving image are provided in a format reproducible on the terminal.

### Supplementary 2

The system according to supplementary 1,
wherein the processor is configured to
control the generative model for visual information generation so that, on the basis of the facial shape information and the expression information and on the basis of a phoneme sequence or time information extracted from the voice information, a plurality of image frames representing temporal changes of a mouth shape and expressions of the deceased person are generated and composed into a video signal.

### Supplementary 3

The system according to supplementary 1,
wherein the processor is configured to
analyze the prompt sentence to detect an instruction specifying at least one of a dialogue scene, a topic, a conversational atmosphere, and an emotional tone, and, in accordance with a content of the instruction, select or weight at least one of a vocabulary distribution, a style pattern, and an emotion tendency among the thought patterns and the language characteristics of the deceased person so as to construct context information to be supplied to the generative language processing model.

### Application Example 2

### Supplementary 1

A system comprising a processor,
wherein the processor is configured to
acquire visual information and behavioral information related to a deceased person, perform preprocessing on the visual information and the behavioral information, and extract features from the preprocessed information,
analyze thought patterns and linguistic styles of the deceased person by applying natural language processing to the extracted behavioral features, model response tendencies on a dialogue-turn basis, and structure and store the modeled response tendencies as style information and thought-pattern information,
extract facial feature points from the visual information of the deceased person by applying image processing, and generate and store appearance information including three-dimensional shape information and expression-deformation information based on the facial feature points,
obtain audio information, image information, or character information from a user, execute emotion-analysis processing on the obtained information, and specify emotion information indicating an emotional state of the user,
dynamically construct a prompt sentence for input to a generative artificial intelligence model, based on the style information, the thought-pattern information, the emotion information, latest utterance content of the user, and dialogue history,
input the prompt sentence into the generative artificial intelligence model, cause the generative artificial intelligence model to generate dialogue text representing speech of the deceased person reflecting the style information and the thought-pattern information, and update the dialogue history with the generated dialogue text,
execute speech-synthesis processing based on the generated dialogue text to generate an audio signal, control expression parameters and motion parameters of the three-dimensional shape information of the deceased person based on the appearance information and the emotion information to generate a visual representation of the deceased person, and generate output data as video synchronized with the audio signal, and
transmit the output data to a user terminal to cause display and playback of the output data and to continue dialogue with the user.

### Supplementary 2

The system according to supplementary 1,
wherein the processor is configured to generate the prompt sentence by inserting a plurality of information elements, including the style information indicating typical expressions, topic tendencies, writing styles, and emotional tones of the deceased person, and further including the emotion information and the latest utterance content of the user, into a template corresponding to a dialogue type.

### Supplementary 3

The system according to supplementary 1,
wherein the processor is configured to dispose the three-dimensional shape information, generated based on the appearance information, in a virtual space, and to control a position, posture, gaze direction, and facial expression of the three-dimensional shape information in accordance with the generated dialogue text and the emotion information, thereby providing an immersive dialogue experience in which the deceased person speaks and responds to the user in a virtual reality environment.

What is claimed is:

1. A system comprising:
circuitry configured to:
acquire, via a communication interface coupled to a packet-switched network, image data and behavior history data associated with a memorized subject, apply image analysis processing to the image data to extract face region data and face feature data, apply natural language processing to the behavior history data to extract phrase sequence data and pragmatic feature data, and store the extracted data as structured data in a storage device;
generate a training dataset from the structured data comprising thinking pattern data and language pattern data of the memorized subject, train a text generation model and an image generation model as generative models using the training dataset so that the trained models reproduce the thinking pattern data and the language pattern data, and store the trained models in the storage device;
receive, via the communication interface, a prompt sentence from a terminal device, input the prompt sentence to at least one of the trained text generation model or image generation model, generate dialogue text data reflecting the thinking pattern data and the language pattern data, and transmit the dialogue text data to the terminal device;
generate, based on the dialogue text data and the face feature data, at least one of moving image data or avatar image data using the image generation model, and transmit the at least one of moving image data or avatar image data in association with the dialogue text data to the terminal device; and
receive at least one of voice data or text data from the terminal device, apply an emotion estimation algorithm to the received data to generate an emotion state parameter, and adjust at least one of output control conditions of the trained models, vocabulary selection parameters, or response pattern parameters based on the emotion state parameter.

2. The system according to claim 1, wherein the circuitry is configured to
apply a convolutional neural network to frames of the image data to generate spatial feature maps, apply a face detection algorithm to the spatial feature maps to locate and extract the face region data, and apply a face feature extraction algorithm to the face region data to generate a face feature vector representation stored as the face feature data.

3. The system according to claim 2, wherein the circuitry is configured to
apply a generative adversarial network to the face feature data to generate synthetic face image data conditioned on the face feature vector representation, and incorporate the synthetic face image data into the training dataset for training the image generation model.

4. The system according to claim 3, wherein the circuitry is configured to
apply a subword tokenizer to the phrase sequence data to generate token sequences, construct dialog-history-inclusive input sequences by associating context token sequences with response token sequences derived from the phrase sequence data, and train the text generation model using the constructed input-response pairs to reproduce the language pattern data.

5. The system according to claim 4, wherein the circuitry is configured to
apply a pragmatic feature extraction algorithm to the behavior history data to identify discourse markers, turn-taking patterns, and stylistic tendencies, incorporate the extracted pragmatic features as conditioning signals during training of the text generation model, and store the pragmatic feature data in the storage device.

6. The system according to claim 1, wherein the circuitry is configured to
construct an input sequence for the text generation model by prepending dialog history data comprising prior prompt sentences and prior dialogue text data to a current prompt sentence, truncate the dialog history data to a maximum context length, and encode the input sequence using a tokenizer prior to inference.

7. The system according to claim 6, wherein the circuitry is configured to
generate a plurality of candidate dialogue text data items by executing the text generation model with different sampling parameters, score each candidate dialogue text data item based on a coherence metric measuring consistency with the thinking pattern data and language pattern data, and select the highest-scoring candidate for transmission to the terminal device.

8. The system according to claim 7, wherein the circuitry is configured to
apply a motion synthesis algorithm to the generated dialogue text data and the face feature data to generate display motion parameter sequences comprising lip-sync data and facial expression data synchronized with the dialogue text data, and incorporate the display motion parameter sequences into the at least one of moving image data or avatar image data.

9. The system according to claim 1, wherein the circuitry is configured to
apply a face landmark detection algorithm to the image data to extract temporal sequences of facial landmark coordinates, compute expression parameter data from the temporal sequences, and store the expression parameter data as an additional component of the face feature data for use in generating the at least one of moving image data or avatar image data.

10. The system according to claim 1, wherein the circuitry is configured to
classify the emotion state parameter into one of a plurality of emotional state categories, select an output control configuration from a plurality of output control configurations based on the classified emotional state category, and apply the selected output control configuration to adjust at least one of a response length parameter, a vocabulary register parameter, or a topic emphasis parameter of the text generation model.

11. The system according to claim 10, wherein the circuitry is configured to
detect a change in the emotion state parameter exceeding a state-change threshold between consecutive inference cycles, regenerate the prompt sentence incorporating the updated emotion state parameter as a contextual condition, and supply the regenerated prompt sentence to the text generation model.

12. The system according to claim 1, wherein the circuitry is configured to
acquire additional behavior history data from a network data source via the communication interface, apply natural language processing to the additional behavior history data to extract supplemental phrase sequence data, construct supplemental training data from the supplemental phrase sequence data, and perform incremental training of the text generation model using the supplemental training data.

13. The system according to claim 12, wherein the circuitry is configured to
compute a consistency metric measuring alignment between dialogue text data generated using the incrementally trained text generation model and the thinking pattern data and language pattern data stored in the storage device, and revert the incremental training when the consistency metric falls below a minimum threshold.

14. The system according to claim 1, wherein the circuitry is configured to
receive a prompt sentence specifying instructions for the image generation model to generate image data depicting the memorized subject in a specified context, input the prompt sentence to the image generation model, receive generated image data from the image generation model, and transmit the generated image data to the terminal device.

15. The system according to claim 14, wherein the circuitry is configured to
apply a style conditioning algorithm to the generated image data using the face feature data to maintain visual consistency with the face feature vector representation, and transmit the style-conditioned generated image data to the terminal device.

16. The system according to claim 1, wherein the circuitry is configured to
encrypt the structured data, the trained models, and the dialogue text data stored in the storage device using an encryption algorithm, and apply a key management protocol to restrict access to the encrypted data to authorized processes executing on the circuitry.

17. The system according to claim 16, wherein the circuitry is configured to
log access events to the stored trained models in an audit log in the storage device, and generate an access report from the audit log for transmission to a designated management terminal upon request.

18. A system comprising:
circuitry configured to:
acquire, via a communication interface coupled to a packet-switched network, image data and behavior history data, extract face feature data using an image analysis algorithm applied to the image data, and extract phrase sequence data and pragmatic feature data using natural language processing applied to the behavior history data;
generate a training dataset from the face feature data, phrase sequence data, and pragmatic feature data, and train a text generation model and an image generation model to reproduce thinking pattern data and language pattern data derived from the training dataset;
receive a prompt sentence from a terminal device, input the prompt sentence to at least one of the trained models to generate dialogue text data and at least one of moving image data or avatar image data, and transmit the dialogue text data and the at least one of moving image data or avatar image data to the terminal device; and
receive at least one of voice data or text data from the terminal device, apply an emotion estimation algorithm to generate an emotion state parameter, and adjust output control conditions of the trained models based on the emotion state parameter.

19. The system according to claim 18, wherein the circuitry is configured to apply a motion synthesis algorithm to the generated dialogue text data and the face feature data to generate display motion parameter sequences comprising lip-sync data and facial expression data synchronized with the dialogue text data, and incorporate the display motion parameter sequences into the at least one of moving image data or avatar image data.

20. A method performed by circuitry, the method comprising:
acquiring, via a communication interface coupled to a packet-switched network, image data and behavior history data associated with a memorized subject, applying image analysis processing to the image data to extract face region data and face feature data, applying natural language processing to the behavior history data to extract phrase sequence data and pragmatic feature data, and storing the extracted data as structured data in a storage device;
generating a training dataset from the structured data comprising thinking pattern data and language pattern data of the memorized subject, training a text generation model and an image generation model as generative models using the training dataset so that the trained models reproduce the thinking pattern data and the language pattern data, and storing the trained models in the storage device;
receiving, via the communication interface, a prompt sentence from a terminal device, inputting the prompt sentence to at least one of the trained text generation model or image generation model, generating dialogue text data reflecting the thinking pattern data and the language pattern data, and transmitting the dialogue text data to the terminal device;
generating, based on the dialogue text data and the face feature data, at least one of moving image data or avatar image data using the image generation model, and transmitting the at least one of moving image data or avatar image data in association with the dialogue text data to the terminal device; and
receiving at least one of voice data or text data from the terminal device, applying an emotion estimation algorithm to the received data to generate an emotion state parameter, and adjusting at least one of output control conditions of the trained models, vocabulary selection parameters, or response pattern parameters based on the emotion state parameter.
